(19) United States
(12) Patent Application Publication
(10) Pub. No.: US 2025/0362509 A1
(43) Pub. Date: Nov. 27, 2025

(54) BIOMETRIC SYSTEM FOR XR HEAD-MOUNTED DISPLAY

(71) Applicant: Hongquan SHEN, Hangzhou (CN)

(72) Inventors: Cheng JlN, Guiyang (CN); Hongquan SHEN, Hangzhou (CN); Yang KONG, Guiyang (CN)

(73) Assignee: Hongquan SHEN, Hangzhou (CN)

(21) Appl. No.: 19/287,008

(22) Filed: Jul. 31, 2025

Related U.S. Application Data
(63) Continuation-in-part of application No. 19/004,794, filed on Dec. 30, 2024.

(51) Int. Cl. G02B 27/01; G02B 27/00; G06V 10/141; G06V 10/143; G06V 10/82; G06V 40/19

(52) U.S. Cl. CPC G02B 27/0172; G02B 27/0093; G06V 10/141; G06V 10/143; G06V 10/82; G06V 40/19; G02B 2027/0138; G02B 2027/014

(57) ABSTRACT

The biometric system for an extended reality head-mounted device, comprising: an imaging optical unit, a illumination optical unit, and an imaging control unit, the imaging optical unit is configured to image near-infrared incident light of an eye/iris, the illumination optical unit is configured to emit related near-infrared light for illuminating the eye/iris, and the imaging control unit is configured to control the eye/iris imaging optical unit and the near-infrared illumination optical unit to generate an eye/iris image in a joint imaging mode.

### CROSS-REFERENCE TO RELATED APPLICATIONS

This application is a continuation-in-part of co-pending application Ser. No. 19/004,794, filed in Dec. 30, 2024, which is a continuation of International Patent Application No. PCT/CN2023/103759 with a filing date of Jun. 29, 2023, designating the United States, now pending, and further claims priority to Chinese Patent Application No. 202211348566.4 filed on Oct. 31, 2022, and Chinese Patent Application No. 202310479638.7, filed on Apr. 28, 2023. The content of the aforementioned applications, including any intervening amendments thereto, are incorporated herein by reference.

### TECHNICAL FIELD

The present application relates to the field of individual biometrics, and in particular to a biometric system for an extended reality (XR) head-mounted display.

### BACKGROUND

An ultra-short focus optical path is a development trend of extended reality (XR). For example, for a virtual reality (VR) head-mounted display form device, an ultra-short MFL is less than 3 mm, an ultra-short TTL is less than 25 mm, and an ultra-short focal length is less than 23 mm. An ultra-short imaging distance is a new challenge for integrating eye/iris imaging configuration on the VR head-mounted display.

AR head-mounted form requires substantial transparency to an exterior environment, so the challenges are greater, which include complex and powerful stray light interference in an outdoor environment.

In addition, influence of specular reflection light interference caused by wearing various optical power/diopter curved surface glasses on the eye/iris image quality also needs to be overcome.

Furthermore, when a human eye observes an XR display content, a rapid movement of a fixation point causes rapid physiological rotation of a human eyeball, the speed is up to 900 degrees/second. The eyeball movement blur caused by the rapid eyeball rotation directly affects the quality of the formed eye/iris image, resulting in failure of identity authentication.

For an optical imaging system multiplexing eye tracking (ET), only the pupil and a central position of a reflected light spot in an imaging image are extracted, which obviously does not have strict requirements on the image quality, but the individual eye/iris biological features across the complex populations are to extract an image detail texture, which obviously has stricter requirements on the image quality.

At present, an overall coupling optimization design of an eye/iris optical imaging system and a head-mounted display optical imaging system needs to be achieved, and the performance of each unit and the whole needs to be improved. Specific parameters and technical indicators of key techniques included in the technical features need to be known, and a related systematic global coupling relationship between the technical parameters is more important.

On this basis, it is necessary to optimize the eye/iris imaging image quality, improve an eye/iris imaging image speed and improve a recognition rate.

### SUMMARY

The embodiments of the present application is to provide a biometric system for an extended reality (XR) head-mounted display, which optimizes the eye/iris imaging image quality, and improves an eye/iris imaging image speed and a recognition rate, so as to overcome the above-mentioned defects.

The biometric system of the embodiments of the present application includes, but is not limited to, individual activity biological features such as eye/iris, retina, subcutaneous tissue of eyes, ophthalmic artery/vein, and sclera.

The biometric system for an extended reality head-mounted device, comprising: an imaging optical unit, a illumination optical unit, and an imaging control unit, the imaging optical unit is configured to image near-infrared incident light of an eye/iris, the illumination optical unit is configured to emit related near-infrared light for illuminating the eye/iris, and the imaging control unit is configured to control the imaging optical unit and the illumination optical unit to generate an eye/iris image in a joint imaging mode.

In accordance with some implementations, the imaging optical unit includes an image sensor, an imaging lens, and a near-infrared optical filter; the imaging optical unit is configured to directly or indirectly image from a predetermined imaging region of eye/iris.

In accordance with some implementations, the imaging optical unit is configured with an angular conversion optical element to convert an angular range of incidence into corresponding an angular range of emergence within a predetermined imaging field of view; the angular range of incidence and the angular range of emergence is configured with a predetermined angular conversion relation.

In accordance with some implementations, the angular conversion optical element is configured with a principal optical axis of the imaging optical unit serving as a normal axis of a symmetry center.

The angular conversion optical element is configured with a predetermined low-order wavefront phase modulation function.

In accordance with some implementations, the angular conversion optical element is configured with a first-order wavefront phase modulation function.

In accordance with some implementations, the angular conversion optical element is configured with an optical conjugation.

In accordance with some implementations, the angular conversion optical element is configured with a centrosymmetric angular range of emergence relative to the principal optical axis.

In accordance with some implementations, the angular conversion optical element is configured with an angular optical compression from angular range of incidence to the angular range of emergence.

In accordance with some implementations, the angular range of emergence less than or equal to an angular range of incidence.

In accordance with some implementations, the joint imaging mode is configured with the angular conversion optical element and the imaging lens in a cascaded arrangement.

In accordance with some implementations, the angular range of emergence is configured as a field of view of the imaging lens in the joint imaging mode.

In accordance with some implementations, the imaging lens is configured to focus onto an image plane of the image sensor by an image-space near-telecentric configuration in the joint imaging mode.

In accordance with some implementations, the angular conversion optical element is configured as an aperture stop located at a front focal plane of the imaging lens in the joint imaging mode.

In accordance with some implementations, the angular conversion optical element is configured with a metasurface optical element or a diffractive optical element.

In accordance with some implementations, the imaging lens is configured with a metalens or a wafer-level optics imaging lens.

In accordance with some implementations, the illumination optical unit is configured to emit light with at least one of a polarization state to the eye.

In accordance with some implementations, the imaging optical unit is configured to capture an image using the image sensor that is sensitive to at least one of a corresponding polarization state.

In accordance with some implementations, the imaging control unit is configured to generate at least one of an identical and orthogonal polarization state combination, synchronize timing and process a polarization intensity data from the image.

In accordance with some implementations, the polarization intensity data is configured with at least one of a pattern modality of corneal polarization interference intensity or pattern modality of scleral polarization scattering intensity serving as a cross-reference feature for characterizing an eye physiological state.

In accordance with some implementations, the imaging control unit is configured to perform end-to-end predictive inference to output dynamic qualitative/quantitative monitoring and analysis of the eye physiological state by pre-training with a high-dimensional mapped dataset of the cross-reference feature via a lightweight machine/deep learning model.

In accordance with some implementations, the cross-reference feature is configured to be defined based on manual feature extraction or autonomous high-dimensional feature extraction via a dual-or multi-channel feature disentanglement block in a machine/deep learning model.

In accordance with some implementations, the imaging control unit is configured with a fixation system to project a predetermined pattern as guided fixation target, analyze the image data, and provide feedback adjustment prompt.

In accordance with some implementations, the illumination optical unit is configured with multi-wavelength multi-polarization state across visible and near-infrared spectra, the imaging optical unit is configured with corresponding pixelated multi-wavelength channel filters to capture an image of multi-wavelength multi-polarization state.

In accordance with some implementations, the polarization state is provided by a metasurface grating with predetermined orientation, subwavelength period and depth.

The biometric system for an XR head-mounted display of the embodiments of the present application includes measurement of individual biological activity.

The biometric system for an XR head-mounted display of the embodiments of the present application includes measurement of physiological state data of biological individuals for individual health state inspection and establishment of a historical data record file.

Compared with the prior art, the configuration of the embodiments of the present application obviously have the advantages and beneficial effects. It can be seen from the above the technical solutions: in the embodiments of the present application, an illumination radiation angle and an illumination angle of emergence of the LED are controlled by the near-infrared illumination optical unit by means of the angle optical assembly to generate related near-infrared light to be emitted to the human eye for illuminating the eye/iris. The eye/iris imaging control unit may be configured to control the eye/iris imaging optical unit and the near-infrared illumination optical unit to generate the eye/iris image in the joint imaging mode. The system can be applicable to an ultra-short MFL/TTL, an ultra-short focus, and an ultra-short imaging distance of various head-mounted display form devices in terms of the problem about integrating eye/iris imaging configuration on the head-mounted display. The problem that the quality of the formed eye/iris image is affected by interference of an exterior environment including complex and powerful stray light in an outdoor environment is solved. In addition, the problem that the eye/iris image quality is affected by specular reflection light interference formed by wearing various optical power/diopter curved surface glasses is solved. Furthermore, the problem that when the human eye observes an XR display content, a rapid movement of a fixation point causes rapid physiological rotation of the human eyeball, and consequently, the formed eye/iris image quality is affected by eye movement blur caused by the rapid eyeball rotation is solved. More importantly, an overall coupling optimization design of an eye/iris optical imaging system and a head-mounted display optical imaging system is achieved, and the performance of each unit and the whole is improved. The technical features include specific parameters and technical indicators relating to key techniques, and a more important related systematic global coupling relationship between the technical parameters. Finally, on this basis, the eye/iris imaging image quality is optimized, and an eye/iris imaging image speed and a recognition rate are improved.

### BRIEF DESCRIPTION OF THE DRAWINGS

FIG. 1 is a schematic diagram of a VR form head-mounted display in example.

FIG. 2 is a schematic diagram of an AR form head-mounted display in example.

FIG. 3 and FIG. 4 are schematic diagrams for reverse optical/optical path conversion of a VR form head-mounted display in example.

FIG. 5 and FIG. 6 are schematic diagrams for reverse optical/optical path conversion of an AR form head-mounted display in example.

FIG. 7 is a schematic diagram for an optical waveguide of an AR form head-mounted display in example.

FIG. 8a is a schematic diagram for 0/30/60/90/120/150 states of polarization of metasurface element, metalens.

FIG. 8b is a schematic diagram for 0/45/90/135/RCP/LCP states of polarization of metasurface element, metalens.

FIG. 9 is a logical time sequence relation diagram of an image frame period parallel synchronization logical time sequence imaging working mode method.

FIG. 10a is a schematic diagram for the angle (ωi/ωo) conversion relationship graphically.

FIG. 10b is a schematic diagram for the tracing rays of the metasurface elements with eye/iris joint imaging mode.

FIG. 10c is a schematic diagram for the tracing rays of the metasurface element with eye/iris illuminating.

FIG. 11 is a schematic diagram for direct imaging in AI/AR glasses.

FIG. 12 is a schematic diagram for indirect imaging in AI/AR glasses.

FIG. 13 is a schematic diagram for retinal illumination in head mounted devices.

FIG. 14 is a schematic diagram for retinal imaging in head mounted devices.

FIG. 15 illustrates the characteristics of the imaging pattern modality.

FIG. 16 is a schematic diagram for retinal illumination and imaging based on optical waveguide.

FIG. 17 is a schematic diagram for retinal illumination and imaging based on optical path scanning.

FIG. 18 shows a partial SEM pattern of the metalens (left) and partial SEM pattern of the metasurface grating structure (right).

### DETAILED DESCRIPTION

The exemplary examples will be described in detail herein and shown in the accompanying drawings exemplarily. When the following descriptions relate to the accompanying drawings, unless otherwise specified, the equivalent numeral in different accompanying drawings denotes the equivalent or similar element. The embodiments described in the following exemplary examples do not denote all the embodiments consistent with the present application. On the contrary, they are merely instances of an apparatus and a method consistent with some aspects of the present disclosure as detailed in the appended claims. In the description of the present disclosure, it is to be noted that the terms “central”, “upper”, “lower”, “front”, “behind”, “left”, “right”, “vertical”, “horizontal”, “top”, “bottom”, “inner”, “outer”, “axial orientation”, “radial orientation”, “inside”, “side”, etc. indicate azimuthal or positional relations based on those shown in the accompanying drawings only for facilitating the description of the present disclosure and for simplicity of description, and are not intended to indicate or imply that the referenced apparatus or element may have a particular orientation and be constructed and operative in a particular orientation, and thus may not be construed as a limitation on the present disclosure.

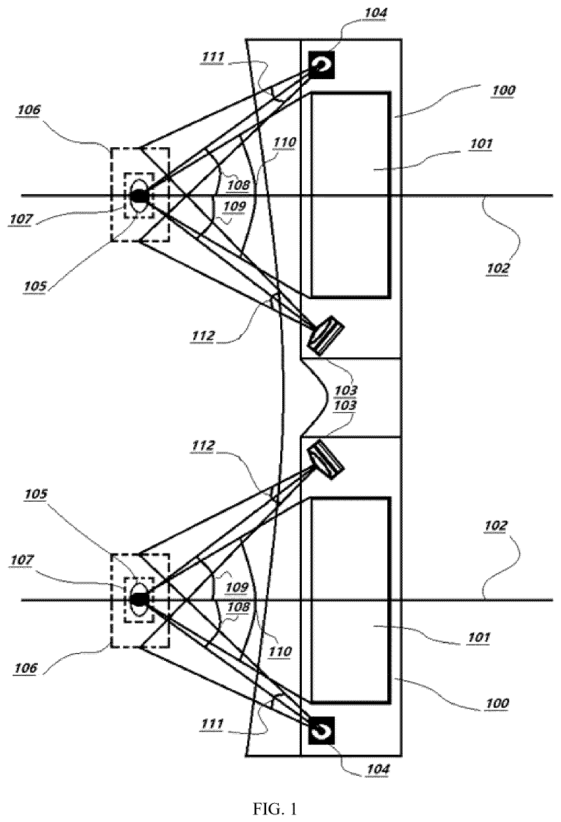

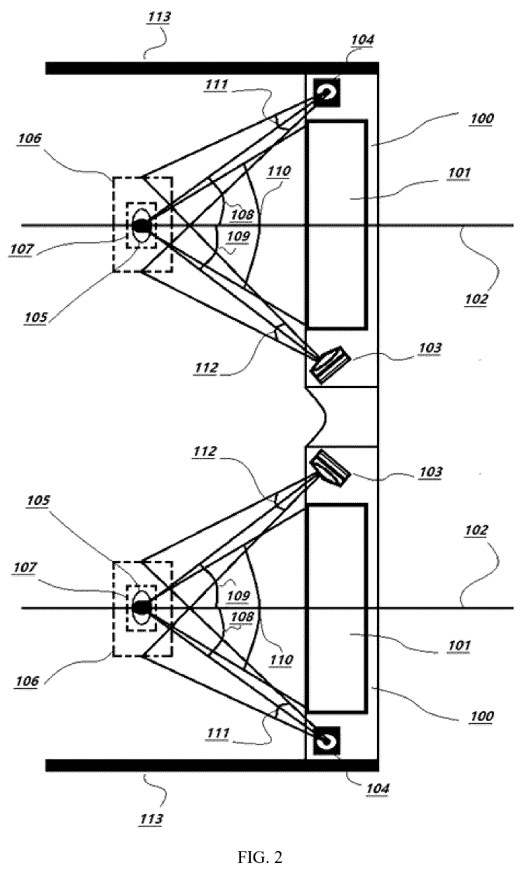

As shown in FIG. 1 and FIG. 2, a biometric system for an extended reality (XR) head-mounted display includes an eye/iris imaging optical unit 103, a display imaging optical unit 101, a near-infrared illumination optical unit 104, and an eye/iris imaging control unit mounted in a virtual reality (VR)/augmented reality (AR) head-mounted display, where the eye/iris imaging optical unit includes an image sensor, an imaging lens, and a near-infrared optical filter for physical imaging of human eye/iris near-infrared incident light.

The display imaging optical unit includes an image display source and a display imaging assembly, and an image display source image is emitted to a human eye for image projecting by means of optical path imaging of the display imaging assembly. The image display source includes an organic light-emitting diode (OLED), a liquid crystal display (LCD), a microOLED, a microLED, etc., and the display imaging assembly includes a VR eyepiece imaging optical assembly (such as a Fresnel lens, a pancake scheme catadioptric lens+¼ retarder waveplate+reflective polarizer, a liquid crystal lens, a liquid lens, and a metasurface lens, metalens), and an AR lens imaging optical assembly (such as a free-form surface lens and an optical waveguide).

The near-infrared illumination optical unit includes a light-emitting diode (LED) and an angle optical assembly, where an illumination radiation angle and an illumination angle of emergence of the LED are controlled by means of the angle optical assembly to generate related near-infrared light to be emitted to a human eye for illuminating an eye/iris.

The eye/iris imaging control unit may be configured to control the eye/iris imaging optical unit and the near-infrared illumination optical unit to generate an eye/iris image in a joint imaging mode.

The near-infrared illumination optical unit is located outside a field of view for observation, FOVd, of the display imaging optical unit, which is invisible in nature related to the human eye observation image and is located on one side (such as left or right side, lower left side or lower right side in some preferred examples) of the display imaging optical unit.

Within an eye relief, an illumination region (RXr, RYr) of the near-infrared illumination optical unit is greater than a predetermined illumination region.

The predetermined illumination region is an eyebox (RXeyebox, RYeyebox) of the display imaging optical unit.

The illumination region (RXr, RYr) of the near-infrared illumination optical unit may be configured as follows:

$$RXr = Kxr * RXeyebox ,$$

$$RYr = Kyr * RYeyebox ,$$

$$Kxr = [ 1.2 , 3 ] , and$$

$$Kxr = [ 1.2 , 3 ] ;$$

alternatively,

$$RXr = RXeyebox + Fxr * ID ,$$

$$RYr = RYeyebox + Fyr * ID ,$$

$$Fxr = [ 0.2 , 2 ] ,$$

$$Fyr = [ 0.2 , 2 ] , and$$

ID represents an iris diameter of the human eye and has an average value of 11 mm.

The illumination region (RXr, RYr) fully considers the Inter-pupillary distance (IPD) difference between the populations and a boundary margin of the illumination region.

The eye/iris imaging optical unit is located outside the field of view for observation, FOVd, of the display imaging optical unit, which is invisible in nature related to the human eye observation image and is located on one side (such as left or right side, lower left side or lower right side in some preferred examples) of the display imaging optical unit.

Within the eye relief, an imaging region (RXi, RYi) of the eye/iris imaging optical unit is greater than a predetermined imaging region.

The predetermined imaging region is the eyebox (RXeyebox, RYeyebox) of the display imaging optical unit.

The imaging region (RXi, RYi) of the eye/iris imaging optical unit may be configured as follows:

$$RXi = Kxi * RXeyebox ,$$

$$RYi = Kyi * RYeyebox ,$$

$$Kxi = [ 1.2 , 3 ] , and$$

$$Kyi = [ 1.2 , 3 ] ;$$

$$alternatively ,$$

$$RXi = RXeyebox + Fxi * ID ,$$

$$RYi = RYeyebox + Fyi * ID ,$$

$$Fxi = [ 0.2 , 2 ] ,$$

$$Fyi = [ 0.2 , 2 ] , and$$

ID represents an iris diameter of the human eye and has an average value of 11 mm.

The imaging region (RXi, RYi) fully considers the Inter-pupillary distance, IPD, difference between the populations and a boundary margin of the imaging region.

The illumination region of the near-infrared illumination optical unit covers and is greater than the imaging region the eye/iris imaging optical unit.

A field of view for illumination (FOI), FOVr of the near-infrared illumination optical unit covers and is greater than a field of view for imaging, FOVi, of the eye/iris imaging optical unit.

The field of view for illumination, FOVr, of the near-infrared illumination optical unit may be configured with field of views in XY horizontal and vertical orientations, FOVxr and FOVyr, where

$$FOVxr = 2 * arctan ( 1 / 2 * RXr / Reyerelif * cos θ r ) , and$$

$$FOVyr = 2 * arctan ( 1 / 2 * RYr / Reyerelif * cos θ r ) .$$

The field of view for imaging, FOVi, of the eye/iris imaging optical unit may be configured with field of views in XY horizontal and vertical orientations, FOVxi and FOVyi, where

$$FOVxi = 2 * arctan ( 1 / 2 * RXi / Reyerelif * cos θ i ) , and$$

$$FOVyi = 2 * arctan ( 1 / 2 * RYi / Reyerelif * cos θ i ) .$$

The near-infrared illumination optical unit controls the field of view for illumination, FOVr, of the near-infrared illumination optical unit by means of the illumination radiation angle.

The eye/iris imaging optical unit controls an imaging region (RXi, RYi) and the field of view for imaging, FOVi, of the eye/iris imaging optical unit by means of pixel resolution and/or object-image spatial resolution, where

$$RXi = PX / PR ,$$

$$RYi = PY / PR ,$$

RXi and RYi represent an imaging region of the field of view for imaging, FOVi, in the X and Y orientations of an object side, with the unit of mm; PX and PY represent the pixel resolution in the X and Y orientations of an image side, with the unit of pixel; and PR represents the object-image spatial resolution with the unit of pixel/mm.

An effective focal length, EFL, of the eye/iris imaging optical unit is greater than a predetermined imaging focal length Fi in the eye relief.

The predetermined imaging focal length Fi=PS*PR*Reyerelif, and

PS represents the unit pixel resolution with the unit of um/pixel of the image sensor.

An imaging depth of field, RZ, of the eye/iris imaging optical unit is greater than a predetermined imaging depth of field.

The predetermined imaging depth of field is the eye relief (Reyerelief) of the display imaging optical unit.

The imaging depth of field, RZ, of the eye/iris imaging optical unit may be configured as follows:

$$RZ = Kz * Reyerelif , and$$

$$Kz = [ 1 , 2 ] .$$

The effective focal length EFL for imaging of the eye/iris imaging optical unit, and a variation range of eye/iris diameter imaging limited within the depth of field range are considered.

The eye/iris imaging optical unit may be configured with an imaging incident angle θi, the imaging incident angle is an included angle between a central optical axis of the eye/iris imaging optical unit and a central optical axis of the display imaging optical unit, and the imaging incident angle θi is less than a predetermined imaging incident angle θip, that is,

$$θ i < θ ip .$$

The predetermined imaging incident angle θip ranges from 30 degrees to 60 degrees, and θip=FOVi/2.

The near-infrared illumination optical unit may be configured with an illumination angle of emergence θr, the illumination angle of emergence is an included angle between a central optical axis of the near-infrared illumination optical unit and a central optical axis of the display imaging optical unit, and the illumination angle of emergence θr is greater than a predetermined illumination angle of emergence θrp, that is,

$$θ r > θ rp or θ r < θ rp .$$

The predetermined illumination angle of emergence θrp ranges from 30 degrees to 60 degrees, and θrp=FOVr/2.

The illumination angle of emergence θr of the near-infrared illumination optical unit is greater than the imaging incident angle θi of the eye/iris imaging optical unit, that is, θr>θi.

In some particular examples, when no optical power/diopter curved glasses are worn, in FIGS. 1 and 2, related to the central optical axis of the display imaging optical unit, the near-infrared illumination optical unit and the eye/iris imaging optical unit are located on same side positions (for example, the left/right side, or the lower left side/the lower right side), and an optical imaging eye/iris image effect is equivalent to that when the two units are located on the opposite side. It is objective that the opposite-side position may be configured with higher uniformity of related illumination RI compared with that of the same-side position.

And, in the embodiments of the present application, in order to eliminate or reduce optical imaging interference caused by specular total reflection on surfaces of wearable optical power/diopter curved surface glasses or complex ambient/internal light reflection, related to the central optical axis of the display imaging optical unit, the effect when the near-infrared illumination optical unit and the eye/iris imaging optical unit are located on the opposite side position has the advantage over that when the two units are located on same side positions based on the position combination configuration rule, and in some examples, the position combination configuration of the near-infrared illumination optical unit and the eye/iris imaging optical unit is that the two units are located on the opposite side position of a nose bridge or lower side. In preferred example, the eye/iris imaging optical unit is located on the nose bridge side position or the lower side position, and the near-infrared illumination optical unit is located on the opposite side position.

Moreover, the illumination angle of emergence θr of the near-infrared illumination optical unit is greater than the imaging incident angle θi of the eye/iris imaging optical unit.

Relatively speaking, the greater the illumination angle of emergence θr of the near-infrared illumination optical unit is, and the lower the imaging incident angle θi of the eye/iris imaging optical unit is, the better the effect of eliminating or reducing the optical imaging interference is, which is more important.

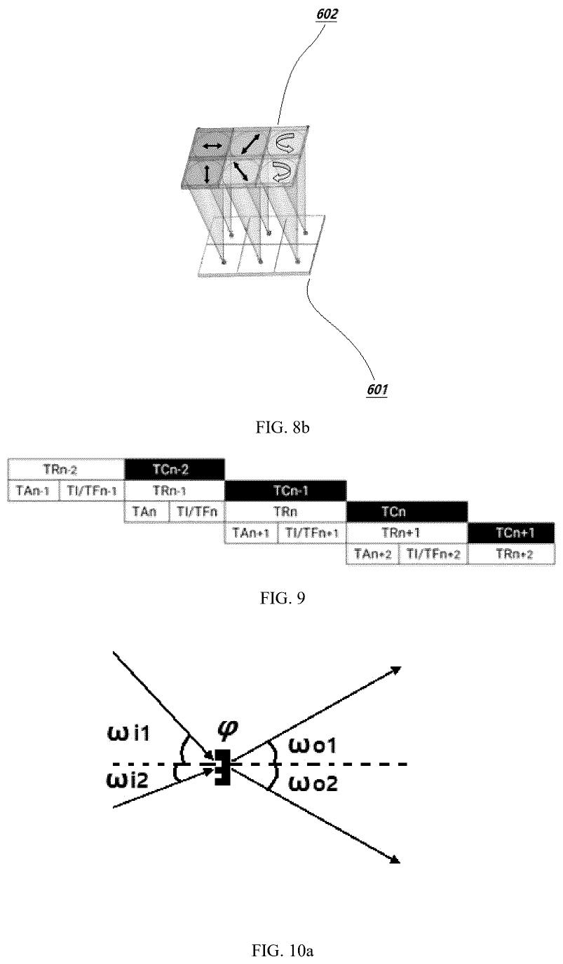

In some embodiments, as shown in FIG. 8, the meta-atom of a metasurface lens element unit array 602 for tunable the optical phase is simulated by a finite difference time domain (FDTD) method to solving the Maxwell boundary equation. By tuning the phase of the wavefront with different arrangement orientations, spacings, heights, rotation angles and/or lengths of the subwavelength nanostructures, so that the light waves of specific wavelength are respectively guided to the predetermined focal plane of sensor pixel unit array 601.

The meta-atom includes the orientation angle of the subwavelength nanostructures in response to a specific polarization state, so that the light waves of the related orientation angle are passed, and the light waves of other orientation angles are blocked and shielded.

In some examples, the eye/iris imaging optical unit of the embodiments of the present application is combined with the near-infrared illumination optical unit to provide a related combined polarization state in a specific orientation of an orthogonal state, thereby eliminating interference of specular reflection light in the related polarization orientation on the surfaces of the worn glasses and in external environment/ambient light. As shown in FIG. 8a, a sensor pixel unit array 601 of the eye/iris imaging optical unit related covers a metasurface lens, metalens, element unit array 602. The metasurface lens, metalens, element unit array 602 may be configured to provide a control incident light phase and a polarization state to be physically focused on the sensor pixel unit, the incident light specific polarization state is focused to the related 601 by means of 602, each related metasurface lens element unit and the sensor pixel unit may be configured to be in the equivalent polarization state, or furthermore, each related metasurface lens element unit and the sensor pixel unit may be configured to be in different polarization states. Schematically, 6 units are shown in FIG. 8. The related metasurface lens element unit and the sensor pixel unit may be configured to be in the equivalent polarization state and may also be separately configured to be in a 0/30/60/90/120/150-degree orientation polarization state to generate a multiple-orientation polarization state imaging attribute, where 0/90, 30/120, and 60/150 are separately configured as orthogonal state combinations, which can provide more imaging image polarization information attributes for individual biological assay, including, but not limited to the biological features which include individual activity, such as an eye/iris, a retina, subcutaneous tissue of eyes, an ophthalmic artery/vein, and a sclera. For example, on the basis of imaging of the biological features of the subcutaneous tissue of eyes and the ophthalmic artery/vein, a higher optical quality image can be provided by means of orthogonal polarization state combination imaging.

Schematically, in an example, 6 units are shown in FIG. 8b. The related metasurface lens element unit and the sensor pixel unit may be configured to be in the equivalent polarization state and may also be separately configured to be in a 0/45/90/135/LCP/RCP orientation polarization state to generate a multiple-orientation polarization state imaging attribute, where 0/90, 45/135, LCP/RCP are separately configured as orthogonal state combinations,

As further shown in FIG. 8a, in the example of the embodiments of the present application illustrates the metasurface element for joint imaging mode. The metasurface element 602 integrated with metapolarizer and metalens is configured for polarizing and focusing to image plane 800 by joint imaging mode.

As mentioned above, the metasurface elements metapolarizer and metalens are combined with the phase modulation of the wavefront by tuning with different arrangement orientations, spacings, heights, rotation angles, lengths of the subwavelength nanostructures.

In an example, the specific linearly polarizer based on all-dielectric diatomic metasurface for an operating wavelength of λ=940 nm (NIR narrow band) comprises a structure of the nanocube phase-shift meta-atom (PM) and a structure of the nanocylindrical without phase shift meta-atom (CM). By tuning the rotation of the PM to specific orientation angle Ψ, the size of the CM and the spatial distance of the PM and CM with appropriate parameters, the all-dielectric diatomic metasurface manipulates arbitrary angle of polarization.

The metasurface element (metapolarizer) shown in FIG. 8 consisted of the period unit cell. It can convert random light into linear polarized light with specific orientation angle Ψ, such as 0/30/60/90/120/150 degrees. The unit cell comprises one PM and one CM, made of TiO2, which are placed on a SiO2 substrate.

Jones matrix of CM is functionally equivalent to rotationally symmetrical unitary 0 phase retarder without phase shifting between two orthogonal axis (x-y).

PM is located at the specific orientation angle Ψ related to the x-axis of the unit cell of metasurface with π phase shifting between two orthogonal axis(x-y), and Jones matrix of PM is functionally equivalent to π phase retarder (½ wave plate). PM and CM combination can be equivalent to a linear polarizer with a polarization angle (Ψ specific orientation angle of PM).

In embodiments of the present application, to find spatial structural parameters of designing a diatomic metasurface composed of PM and CM, finite-difference time-domain (FDTD, Lumerical Solutions) simulations are performed. The spatial structural parameters of designing include but not limited to, the lattice of diatomic meta-atoms P=[λ/2,λ/sqrt(2)] nm (Nyquist principle),equivalent height of PM and CM H=[λ/2,λ/(n−1)] nm, the length and width of the PM L/W=[100,P−100] nm, the radius of CM R=[100,P−100] nm.

For efficient implementation of various phase modulation mechanisms, high-refractive-index dielectrics (n around 2.0 or higher) are preferred. Common candidate materials include titanium dioxide (TiO2), hafnium oxide (HfO2), gallium nitride (GaN),and silicon nitride (SiNx). For examples operating in the NIR wavelength, silicon (Si), which exhibits a high refractive index (n>3.5) and acceptable extinction coefficient, can be used as well. Certain low-refractive-index (n<2.0) dielectrics, such as silicon dioxide (SiO2) and polymers, can also be employed to construct metasurface based on the geometric phase or propagation phase. In order to compensate for their related low refractive index, high-aspect-ratio structures are typically required. Precisely patterning the aforementioned materials into high-aspect-ratio and low-loss subwavelength nanostructures is essential to high-performance metasurface operation. In conventional fabrication processes, the designed metasurface patterns are first created in the resist layer through deep ultraviolet (DUV) or electron beam (e-beam) lithography and then transferred onto the target dielectric layer through dry etching. Nanoimprint lithography (NIL), which generates nano-to micro-scale structures through mechanical pressing with the aid of heating or UV radiation, has been exploited as an alternative method for low-cost and high-throughput metasurface fabrication over large areas.

In embodiments of the present application, the metasurface elements (metapolarizer, metacoupler, metalens, metaconverter, etc.) for the eye/iris illumination optical unit (LED) and/or imaging optical unit (CMOS sensor, etc.) are integrated with WLO (Wafer Level Optics) flat/planar optics manufacturing technology by standardized CMOS compatible semiconductor platform.

In embodiments of the present application, the basic principles of designing for metasurface element metalens is configured with the phase modulation function φ(following equation) by giving focal length f, numeric [symbol] aperture NA,FOV (FOVi,FOVr etc.),or angular range of incident rays within diffraction limited to image plane. The simulation software (Zemax/Code V/Optics studio) traces the incident rays and tunes the order coefficients a n to minimize the PSF on the image plane within diffraction limited (within diameter D=2.44λ/NA).

$$φ ( r ) = - 2 π * / λ * [ {( {r}^{2} + {f}^{2} )}^{1 / 2} - f ]$$

$$φ ( r ) = {\sum }_{n} {{a}_{n} ( \frac{r}{R} )}^{2 n}$$

where, R means normalized radius of phase modulation function, r means argument radius of phase modulation function, an means order coefficient of phase modulation function, 2n means order of Taylor expansion of phase modulation function, it only considers even terms, due to phase profile is radially symmetric.

Certainly, different combinations, such as 0/45/90/135-degree orientation polarization states are also be understood in the equivalent way, where 0/90 and 45/135 are separately configured as orthogonal combinations.

In the equivalent way, the near-infrared illumination optical unit can also provide related multiple-orientation polarization state illumination by means of the metasurface lens, metalens. In some examples, the near-infrared illumination optical unit provides a 0 and/or 90-degree (the equivalent and/or orthogonal) polarization state combination attribute corresponding to the eye/iris imaging optical unit, and the combination attribute includes, but is not limited to, 0/45/90/135/LCP/RCP.

Furthermore, the metasurface element, metalens further provides emergent light flood illumination for the near-infrared illumination optical unit to generate a high-uniformity optical radiation intensity distribution within the predetermined field of view for illumination, FOVr, of emergent light. In some examples, a rectangular light spot for projecting the FOVr high-uniformity radiation intensity distribution improves the related illumination RI within the field of view FOVi range.

Due to a limitation on a mounting position, which requires the near-infrared illumination optical unit to be located outside the field of view for observation, FOVd, of the display imaging optical unit, the illumination angle of emergence of the near-infrared illumination optical unit satisfies θr>FOVd/2 based on such a structure limitation, which completely satisfies the condition of 30-60 degrees in practice. In view of the situation that if the illumination angle of emergence θr of the near-infrared illumination optical unit is too large, the related illumination RI, cos3θr is reduced, and a light energy utilization rate is also essentially reduced, 60 degrees should be an upper limit. A related illumination RI fixed model correction compensation process may be employed in the range of 45-60 degrees.

In the equivalent way, due to a limitation on a mounting position, which requires the eye/iris imaging optical unit to be located outside the field of view for observation, FOVd, of the display imaging optical unit, the imaging incident angle of the eye/iris imaging optical unit satisfy θi>FOVd/2 based on such a structure limitation.

In particular, when limitation is generated in both the X and Y orientations, such an ultra-large imaging incident angle non-coaxial (off-axis) imaging system causes imaging performance problems, such as spatial perspective transformation and distortion, and related illumination. Although a spatial perspective transformation or fixed distortion model correction compensation method can be used to partially reduce the optical distortion caused by a too large spatial field of view in a limited extent, a related illumination effect still exists. Especially for an eye/iris recognition application algorithm in machine vision, the detail pixel texture contrast and pixel TV distortion requirements of imaging eye/iris images are required.

Therefore, reduction of the imaging incident angle of the eye/iris imaging optical unit is one of the objectives of the embodiments of the present application.

As shown in FIG. 1/2 in the example of the embodiments of the present application, direct imaging of the eye/iris imaging optical unit is from near-infrared light emitted from the eye/iris.

When the imaging incident angle θi of the eye/iris imaging optical unit exceeds the predetermined imaging incident angle θip (θi>θθip), the eye/iris imaging optical unit increases the imaging region (RXi, RYi) and the field of view for imaging, FOVi. In some particular examples, the imaging incident angle θi is reduced and satisfies θi<θip by improving the pixel resolution (PX, PY) in the X and Y orientations of the eye/iris imaging optical unit and/or reducing the object-image spatial resolution PR of the eye/iris imaging optical unit.

Furthermore, exemplary, 60 degrees decrease to 45 or 30 degrees to related increase the pixel resolution (400 pixel, 400 pixel) in the X and Y orientations of the eye/iris imaging optical unit to (512 pixel, 512 pixel) or (600 pixel, 600 pixel), or reduce the object-image spatial resolution, 16 pixel/mm, of the eye/iris imaging optical unit to 13 pixel/mm or 10 pixel/mm.

The pixel resolution (PX, PY) in the X and Y orientations of the eye/iris imaging optical unit is increased and the object-image spatial resolution PR of the eye/iris imaging optical unit is reduced in a synchronous and combined manner, and 60 degrees decreases to 45 or 30 degrees to increase the pixel resolution (400 pixel, 400 pixel) in the X and Y orientations of the eye/iris imaging optical unit to (460 pixel, 460 pixel) or (512 pixel, 512 pixel) and reduce the object-image spatial resolution, 16 pixel/mm, of the eye/iris imaging optical unit to 14 pixel/mm or 13 pixel/mm.

In the equivalent way, as shown in FIG. 1/2 in the example of the embodiments of the present application, the near-infrared illumination optical unit directly illuminates near-infrared light and emits the near-infrared light to the eye/iris, and the illumination angle of emergence θr of the near-infrared illumination optical unit exceeds the predetermined illumination angle of emergence θrp, that is, θr>θrp.

As a further improved feature of imaging of the eye/iris imaging optical unit of the embodiments of the present application, a predetermined angle conversion optical element is mounted in front (defined according to an optical propagation orientation) of the eye/iris imaging optical unit 103 to perform combined optical imaging. The predetermined angle conversion optical element is explained for a physical action and is defined based on an optical path propagation orientation. Different light incident angles ωi from human eye/iris emission are first incident to the predetermined angle conversion optical element and then emitted to the eye/iris imaging optical unit 103 at a related light angle of emergence ωo. In some examples, the predetermined angle conversion optical element may be configured as follows: the incident angle ωi and the related angle of emergence wo have a predetermined conversion relationship:

$$tan ω o = tan ω i / ( cos θ i - sin θ i * tan ω i ) ,$$

$$ω i = [ - FOVi / 2 , FOVi / 2 ] , and$$

ωi and ωo take the optical axis of the eye/iris imaging optical unit tilting at an angle of θi as a normal axis of a symmetry center.

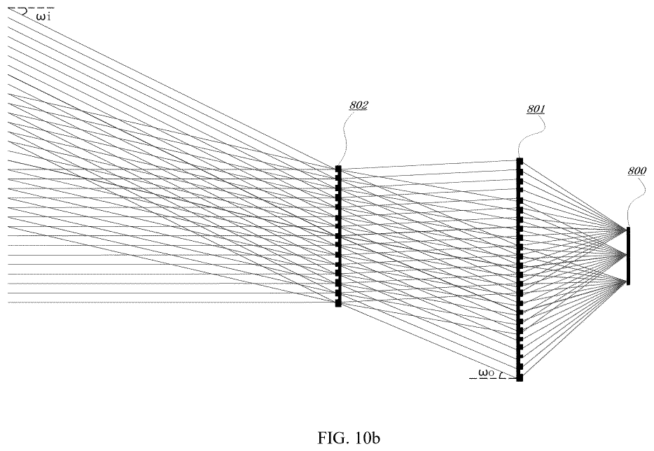

In the example of the embodiments of the present application, As shown in FIG. 10a, illustrates the angle (ωi/ωo) conversion relationship graphically by angular related dimensions, where the dashed line is the normal axis. The principled explanation of the conversion relationship with phase modulation function of the metasurface element metaconverter is functional transmit incident angle ωi1/ωi2 to related angle of emergence ωo1/ωo2 within FOVi (i.e. ωi1 to ωo1, ωi2 to ωo2). The phase modulation of the wavefront φ(phase gradient φ′) is expressed by generalized snell's law: no*sinωo−ni*sinωi=λ/2π*φ′.

It is more advantageous to simplify the physical implementation of the off-axis metasurface optical element by means of corresponding to incident angle/angle of emergence ωi/ωo with the optical axis of the eye/iris imaging optical unit tilting at the angle of θi as the normal axis of the symmetry center.

The above-described high-order nonlinear angle conversion relationship corresponding to phase modulation function further simplifies the approximate low-order (phase profile). In some examples, the predetermined angle conversion optical clement includes, but not limited to, a metasurface optical element. The metasurface optical clement is provided with a tunable sub-wavelength spatial structure, such that the tunable incident angle/angle of emergence conversion degree of freedom range has the advantage over the other optical element.

By means of the incident angle/angle of emergence conversion, inverse transformation of the optical property of an oblique off-axis incident imaging effect can be essentially achieved by the eye/iris imaging optical unit, and the optical properties such as imaging region perspective, and distortion within the range of the field of view for imaging are essentially improved.

As further shown in FIG. 10b,in the example of the embodiments of the present application illustrates the metasurface element for joint imaging mode. The metaconverter 802 is configured for manipulating the conversion relationship and the metalens 801 is configured for focusing to image plane 800 by joint imaging mode. As mentioned above, the metasurface element metaconverter 802 and metalens 801 are combined with the phase modulation of the wavefront by tunning with different arrangement orientations, spacings, heights, rotation angles, lengths of the subwavelength nanostructures.

Further, cascades of the metaconverter 802 and the metalens 801 can be equivalent to individual integrated element.

According to the equivalent principle, a further improved uniform feature of the illumination optical unit of the embodiments of the present application, a predetermined angle conversion optical clement is mounted in front (defined according to an optical propagation orientation) of the illumination optical unit 104 to perform combined optical illumination. The predetermined angle conversion optical clement is explained for a physical action and is defined based on an optical path propagation orientation. Different angle of incident Φi from illumination optical unit 104 emission are first incident to the predetermined angle conversion optical element and then emitted to the eye/iris at a related angle of emergence Φo. In some examples, the predetermined angle conversion optical element may be configured as follows: the incident angle Φi and the related angle of emergence Φo have a predetermined conversion relationship:

$${cos}^{2} Φ o = cos Φ i , or {cos}^{3} Φ o = cos Φ i etc .$$

$$Φ o = [ θ r - FOVr / 2 , θ r + FOVr / 2 ] , and$$

Φi and Φo take the optical axis of the illumination optical unit tilting at an angle of θr as a normal axis of a symmetry center.

As shown in FIG. 10c in the example of the embodiments of the present application illustrates the angle (Φo/Φi) conversion relationship graphically, showing the relationship between incident angle and angle of emergence by density of ray. The metasurface element metaconverter 701 is configured for manipulating the conversion relationship to illuminating eye/iris. The above-described high-order nonlinear angle conversion relationship corresponding to phase modulation function further simplifies the approximate low-order (4-8order). The phase modulation of the wavefront φ(phase gradient φ′) is expressed by generalized snell's law: no*sinΦo−ni*sinΦi=λ/2π*φ′.

It is more advantageous to simplify the physical implementation of the off-axis metasurface optical element by means of a related incident angle/angle of emergence Φi/Φo with the optical axis of the eye/iris illumination optical unit tilting at the angle of θr as the normal axis of the symmetry center.

In some examples, the predetermined angle conversion optical element includes, but not limited to, a metasurface optical element metaconverter. The metasurface optical element is provided with an tunable sub-wavelength spatial structure, such that the tunable incident angle/angle of emergence conversion degree of freedom range has the advantage over the other optical element.

By means of the incident angle/angle of emergence conversion, inverse transformation of the optical property of an oblique off-axis emergent illumination effect can be essentially achieved by the eye/iris illumination optical unit, and the optical properties such as related illumination RI uniform rate and a light energy utilization rate of illumination region are essentially improved.

As a further improved feature of the embodiments of the present application, indirect imaging from the near-infrared light emitted from the eye/iris is achieved by means of reverse optical/optical path conversion in some particular examples of the embodiments of the present application.

An optical path of the eye/iris imaging optical unit transmits the near-infrared light emitted from the eye/iris by means of the reverse optical refraction and/or reflection conversion of an imaging optical path of the display imaging assembly.

By means of an extended virtual distance of a reverse optical/optical path conversion imaging optical path, the imaging incident angle θi between the eye/iris imaging optical unit and the display imaging optical assembly is reduced. The requirement that θi<θip is satisfied.

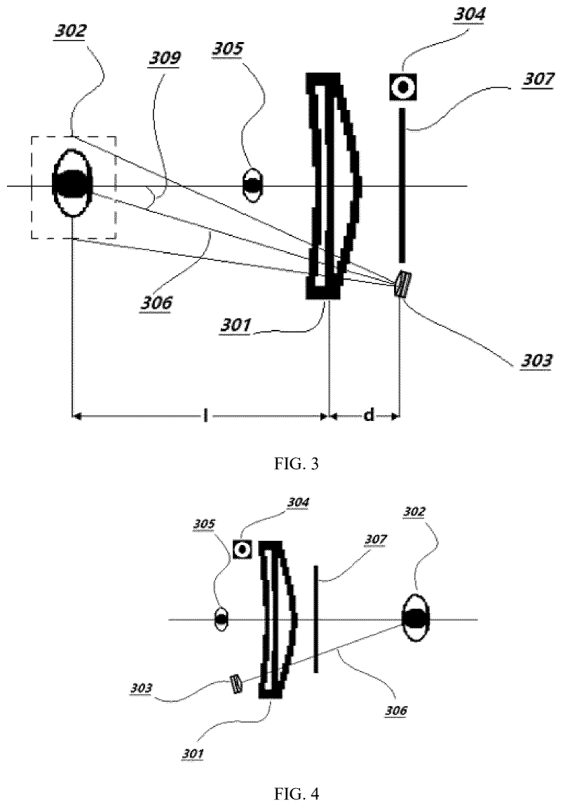

In some particular examples of the embodiments of the present application, the head-mounted display is a VR form head-mounted display. As shown in FIG. 3, the display imaging assembly includes a VR eyepiece imaging optical assembly (including a Fresnel lens, a pancake scheme catadioptric lens+¼ retarder waveplate+reflective polarizer, a liquid crystal lens, a liquid lens, a metasurface lens, metalens, etc.).

The liquid crystal lens, the liquid lens, and the metasurface lens, metalens, have electromagnetic tunable varifocal potential, can satisfy user's requirements on different optical power/diopter curved surface adjustment, and can overcome a visual convergence adjustment conflict phenomenon.

The eye/iris imaging optical unit is located outside the field of view for observation, FOVd, of the display imaging optical unit, which is invisible in nature related to the human eye observation image and is located on one side (in some preferred examples, it may be located on the nose bridge side, and the opposite side as the near-infrared illumination optical unit) of the display imaging optical unit. More specifically, the eye/iris imaging optical unit is converted to be located in behind of the VR eyepiece imaging optical assembly (including a Fresnel lens, a pancake scheme catadioptric lens+¼ retarder waveplate+reflective polarizer, a liquid crystal lens, a liquid lens, a metasurface lens, metalens, etc.), and is located on the positions, including but not limited to, being in front of or behind of the image display source. By means of such reverse optical/optical path conversion, the imaging optical path is formed by means of refraction of the VR eyepiece imaging optical assembly on indirect imaging, which is from near-infrared light emitted from the eye/iris, of the eye/iris imaging optical unit. By means of an extended combined virtual distance of the imaging optical path, the imaging incident angle θi between the eye/iris imaging optical unit and the VR eyepiece imaging optical assembly is reduced.

In some examples, the eye/iris imaging optical unit is converted to be located inside of the VR eyepiece imaging optical assembly (including a Fresnel lens, a pancake scheme catadioptric lens+¼ retarder waveplate+reflective polarizer, a liquid crystal lens, a liquid lens, a metasurface lens, metalens, etc.).

In some examples, as shown in FIG. 3, reverse optical/optical path conversion is employed to provide the combined virtual object distance 306, thereby achieving reduction within 20 degrees of θi, such as 15/17 degrees or even lower. In fact, the influence of optical properties such as angle perspective and distortion formed by an incident angle (cos20=0.94) of 20 degrees or below can be substantially ignored related to the imaging image quality used for algorithm processing.

The combined virtual distance of the eye/iris imaging optical unit provide the optical properties needed to essentially manipulate the imaging incident angle θi.

The combined virtual distance refers to a combination between a virtual object distance provided by the imaging optical path of the display imaging assembly and a physical distance from an optical principal plane of the imaging optical path of the display imaging assembly to an optical principal plane of the eye/iris imaging optical unit.

As shown in FIG. 3, the combined virtual object distance s of the eye/iris imaging optical unit is a combination between a virtual object distance l provided by the imaging optical path of the display imaging assembly and a physical spacing distance d from an optical principal plane (principal point) of the imaging optical path of the display imaging assembly to an optical principal plane (principal point) of the eye/iris imaging optical unit, that is, s=(l+d).

The effective focal length EFL for imaging of the eye/iris imaging optical unit may be configured as follows:

$$EFL = β * s / ( β - β 1 ) / cos θ i >= β * s / ( β - β 1 ) ,$$

where β=−PR*PS, which is a magnification of a combined imaging vertical axis of the predetermined image quality standard; α1=f1/(−Reyerelif−p+f1), which is a magnification of a vertical axis provided by the imaging optical path of the display imaging assembly; f1 is an equivalent focal length of the display imaging assembly; p is a distance from an optical principal point of the imaging optical path of the display imaging assembly and a vertex of a first front surface; and Reyerelif+p is an object distance between the eye/iris and the imaging optical path of the display imaging assembly.

Furthermore, the structural mounting position limits the physical spacing distance g=15 mm between the eye/iris imaging optical unit and the display imaging assembly, and the imaging incident angle θi=arctan(g/s)=20 degrees.

PR=20 pixel/mm, PS=2.5 um/pixel, f1=30 mm, p=2 mm, Reyerelif=13 mm, l=30 mm, d=10 mm, and EFL=0.9756 mm/1.038 mm.

The effective focal length EFL for imaging of the eye/iris imaging optical unit for indirect imaging is not significantly increased compared to direct imaging, and mounting can be performed in a display imaging optical unit space in terms of a construction space.

The field of view for imaging, FOVi, of the eye/iris imaging optical unit may be configured with field of views in XY horizontal and vertical orientations, FOVxi and FOVyi, where

$$FOVxi = 2 * arctan ( 1 / 2 * β1 * RXi / s * cos θ i ) ,$$

$$and$$

$$FOVyi = 2 * arctan ( 1 / 2 * β1 * RYi / s * cos θ i ) .$$

In some examples, in an extreme case in which the angle formed by means of direct configuration of the indirect imaging incident angle θi is 0 degree, the combined virtual object distance of the eye/iris imaging optical unit described above supports cancellation of oblique imaging incident angle configuration.

The optical properties such as angle perspective and distortion formed by the imaging incident angle θi are substantially reduced by means of the indirect imaging device of the embodiments of the present application, and moreover, the predetermined image quality requirements are satisfied.

The spatial structure is reasonable and compact. The eye/iris imaging optical unit is located in the space of the display imaging optical unit and is substantially invisible, and the hidden appearance is more in line with ergonomics.

The VR eyepiece imaging optical assembly described above configures optical surfaces with a related adaptive optical power/diopter curve. In some examples, the optical surfaces may include, but not limited to, part or all of the surfaces of optical elements. The provided configuration substantially responds to high transmittance of near-infrared light NIR. In the example, a coating is employed to achieve narrow band 30-60 nm or 800-1000 nm broadband transmittance of over 90%, and reflectivity of below 1% for NIR850/940 nm.

In some examples, a pancake catadioptric optical path may be employed in the eye/iris imaging optical unit, and a reflective polarizer, a ¼ retarder waveplate and a catadioptric lens are used. The near-infrared reflected light of the human eye/iris is naturally polarized or randomly polarized, and propagation of the refractive (Non-Reflecting) optical path has no substantial attenuation, distortion, or wavefront error by optimized optical imaging elements

The specific-orientation polarized light incident to the eye/iris imaging optical unit through the reflective polarizer has special effects and can eliminate interference of specular reflection light in the related polarization orientation on surfaces of worn glasses and in an external environment/internal light in combination with a related polarization state in an orthogonal state orientation of the near-infrared illumination optical unit.

Furthermore, in some examples, reflective polarizer is configured with specific-orientation (P) polarization state for emergent light.

The specific-orientation polarization state of incident light of the eye/iris imaging optical unit is configured with an identical (CP) polarization state, and is used for direct imaging of incident light through the pancake catadioptric optical path without reflection (essentially refraction).

The related orthogonal polarization state of emergent light of the near-infrared illumination optical unit is configured with circular polarization (CP), and is used for direct emergent light through the pancake catadioptric optical path without reflection (essentially refraction). The circular polarization (CP) state is converted to the P polarization state by ¼ retarder waveplate.

In some examples, the configuration of polarization state of the eye/iris imaging optical unit may be omitted.

The above-described the (P) and the(S) polarization state are equivalent substitutions.

Furthermore, in some examples, as shown in FIG. 4, indirect imaging from the near-infrared light emitted from the eye/iris is achieved by means of reverse optical/optical path conversion in some particular examples of the embodiments of the present application.

The eye/iris imaging optical unit is located outside the field of view for observation, FOVd, of the display imaging optical unit, which is invisible in nature related to the human eye observation image and is located on one side (in some preferred examples, it may be located on the nose bridge side, and the opposite side as the near-infrared illumination optical unit) of the display imaging optical unit. More specifically, the eye/iris imaging optical unit is converted to be located in front of or inside of the VR eyepiece imaging optical assembly (including a Fresnel lens, a pancake scheme catadioptric lens+¼ retarder waveplate+reflective polarizer, a liquid crystal lens, a liquid lens, a metasurface lens, metalens, etc.).

The VR eyepiece imaging optical assembly described above configures optical surfaces with a related adaptive optical power/diopter curve. In some examples, the optical surfaces may include, but not limited to, part or all of the surfaces of optical elements. The provided configuration substantially responds to high reflectivity of near-infrared light NIR. In the example, a coating is employed to achieve narrow band 30-60 nm or 800-1000 nm broadband reflectivity of over 90%, and transmittance of below 1% for NIR850/940 nm.

For such a reverse optical/optical path conversion, imaging of the eye/iris imaging optical unit is from the near-infrared light emitted from the eye/iris, which is reflected to form the imaging optical path by means of the VR eyepiece imaging optical assembly. By means of an extended virtual distance of the imaging optical path, the imaging incident angle θi between the eye/iris imaging optical unit and the VR eyepiece imaging optical assembly is reduced.

In some examples, as shown in FIG. 4, reverse optical/optical path conversion is employed to provide a virtual object distance 306, thereby achieving reduction within 20 degrees of θi, such as 15/17 degrees or even lower.

Furthermore, due to the specific-orientation polarization state of the VR eyepiece imaging optical assembly described above, the optical path of the eye/iris imaging optical unit may be multiple refracting and reflecting, which results in an extended virtual distance of the imaging optical path.

The specific-orientation polarized light incident to the eye/iris imaging optical unit can eliminate interference of specular reflection light in the related polarization orientation on surfaces of worn glasses and in an external environment/internal light in combination with a related polarization state in an orthogonal state orientation of the near-infrared illumination optical unit.

Furthermore, the specific-orientation polarization state of incident light of the eye/iris imaging optical unit is configured with the first (P) polarization state, and related orthogonal polarization state of emergent light of the near-infrared illumination optical unit is configured with the second(S) polarization state.

The above-described the first (P) and the second(S) polarization state are equivalent substitutions.

The head-mounted display mentioned in the particular example of the embodiments of the present application is an AR form head-mounted display. As shown in FIG. 5, the display imaging assembly includes an AR lens imaging optical assembly (which may also be a free-form surface lens, a prism, a BB, an optical waveguide, etc.).

The eye/iris imaging optical unit is located outside the field of view for observation, FOVd, of the display imaging optical unit, which is invisible in nature related to the human eye observation image and is located on one side (in some preferred examples, it may be located on the nose bridge side, and the opposite side as the near-infrared illumination optical unit) of the display imaging optical unit. More specifically, the eye/iris imaging optical unit is converted to be located in behind of or inside of an AR lens imaging optical assembly.

For such a reverse optical/optical path conversion, imaging of the eye/iris imaging optical unit is from the near-infrared light emitted from the eye/iris, which is refracted to form the imaging optical path by means of the AR lens imaging optical assembly. By means of an extended virtual distance of the imaging optical path, the imaging incident angle θi between the eye/iris imaging optical unit and the AR lens imaging optical assembly is reduced.

In some examples, as shown in FIG. 5, reverse optical/optical path conversion is employed to provide a virtual object distance 406, thereby achieving reduction within 20 degrees of θi, such as 15/17 degrees or even lower.

The AR lens imaging optical assembly described above configures optical surfaces with a related adaptive optical power/diopter curve. In some examples, the optical surfaces may include, but not limited to, part or all of the surfaces of optical elements. The provided configuration substantially responds to high transmittance of near-infrared light NIR. In the example, a coating is employed to achieve narrow band 30-60 nm or 800-1000 nm broadband transmittance of over 90%, and reflectivity of below 1% for NIR850/940 nm.

Furthermore, the specific-orientation polarization state of incident light of the eye/iris imaging optical unit is configured with first (P) polarization state, and related orthogonal polarization state of emergent light of the near-infrared illumination optical unit is configured with the second(S) polarization state.

The above-described the first (P) and the second(S) polarization state are equivalent substitutions.

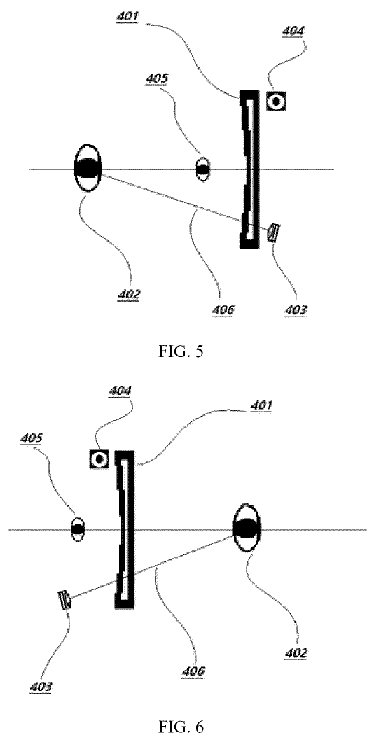

Furthermore, indirect imaging from the near-infrared light emitted from the eye/iris is achieved by means of reverse optical/optical path conversion in some particular examples of the embodiments of the present application. As shown in FIG. 6, the eye/iris imaging optical unit is located outside the field of view for observation, FOVd, of the display imaging optical unit, which is invisible in nature related to the human eye observation image and is located on one side (in some preferred examples, it may be located on the nose bridge side, and the opposite side as the near-infrared illumination optical unit) of the display imaging optical unit. More specifically, the eye/iris imaging optical unit is converted to be located in front of or inside of an AR lens imaging optical assembly.

For such a reverse optical/optical path conversion, imaging of the eye/iris imaging optical unit is from the near-infrared light emitted from the eye/iris, which is reflected to form the imaging optical path by means of the AR lens imaging optical assembly. By means of an extended virtual distance of the imaging optical path, the imaging incident angle θi between the eye/iris imaging optical unit and the AR lens imaging optical assembly is reduced. In some examples, as shown in FIG. 6, reverse optical/optical path conversion is employed to provide a virtual object distance 406, thereby achieving reduction within 20 degrees of θi, such as 15/17 degrees or even lower.

The AR lens imaging optical assembly described above configures optical surfaces with a related adaptive optical power/diopter curve. In some examples, the optical surfaces may include, but not limited to, part or all of the surfaces of optical elements. The provided configuration substantially responds to high reflectivity of near-infrared light NIR. A coating may also be employed to achieve narrow band 30-60 nm or 800-1000 nm broadband reflectivity of over 90%, and transmittance of below 1% for NIR850/940 nm. The equivalent optical conversion uses a near-infrared thermal reflector, hot mirror, etc. which is placed on an appropriate imaging optical path.

Furthermore, the specific-orientation polarization state of incident light of the eye/iris imaging optical unit is configured with the first (P) polarization state, and related orthogonal polarization state of emergent light of the near-infrared illumination optical unit is configured with the second(S) polarization state.

The above-described the first (P) and the second(S) polarization state are equivalent substitutions.

In application of forward optical/optical path conversion with the equivalent principle, as shown in the above example and FIG. 3/5, the near-infrared illumination optical unit 304/404 employs equivalent forward optical/optical path conversion to achieve indirect illumination of near-infrared light emitted to the eye/iris, and is set corresponding to the eye/iris imaging optical unit.

An optical path of the near-infrared illumination optical unit transmits the near-infrared light and emits equivalent to the eye/iris by means of the forward optical refraction and/or reflection conversion of the imaging optical path of the display imaging assembly.

Owing to the forward optical/optical path conversion, the illumination angle of emergence θr between the near-infrared illumination optical unit and the VR eyepiece imaging optical assembly, and the illumination angle of emergence θr between the near-infrared illumination optical unit and the AR lens imaging optical assembly are reduced by means of the extended virtual distance of the illumination optical path.

related, the illumination angle of emergence θr is less than the predetermined illumination angle of emergence θrp, that is, θr<θrp. related illumination RI and a light energy utilization rate of the imaging region within the range of the field of view for imaging are improved.

For some particular examples, as shown in FIG. 3, the virtual distance s2=12+Reyerelif+p, and 12=f1*d2/(−d2+f1)=β2*d2.

For some particular examples, f1=30 mm, p=2 mm, Reyerelif=13 mm, 12=30 mm, d2=15 mm, and s2=45 mm, where d2 is an object distance between the near-infrared illumination optical unit and the display imaging assembly.

The structural mounting position limits the physical spacing distance g2=15 mm between the near-infrared illumination optical unit and the display imaging assembly, and the illumination angle of emergence θr-arctan(β2*g2/s2)=33.6 degrees, which still satisfies the configured optical property, that is, θr>θi.

The field of view for illumination, FOVr, of the near-infrared illumination optical unit may be configured with field of views in XY horizontal and vertical orientations, FOVxr and FOVyr, where

$$FOVxr = 2 * arctan ( 1 / 2 * β 2 * RXr / s 2 * cos θ r ) ,$$

$$and$$

$$FOVyr = 2 * arctan ( 1 / 2 * β 2 * RYr / s 2 * cos θ r ) .$$

As shown in the above example, the near-infrared illumination optical unit is arranged corresponding to the eye/iris imaging optical unit. It should be specially noted that the position of the near-infrared illumination optical unit should be considered to avoid the emergent light from being focused and guided to a user's retina by a crystalline lens, thereby avoiding occurrence of thermal and retinal radiation damage.

In the embodiments of forward/reverse optical/optical path conversion with the equivalent principle, the near-infrared illumination optical unit and the eye/iris imaging optical unit is located on the positions, including but not limited to, being in front of, or inside of, or behind of optical elements of the display imaging assembly.

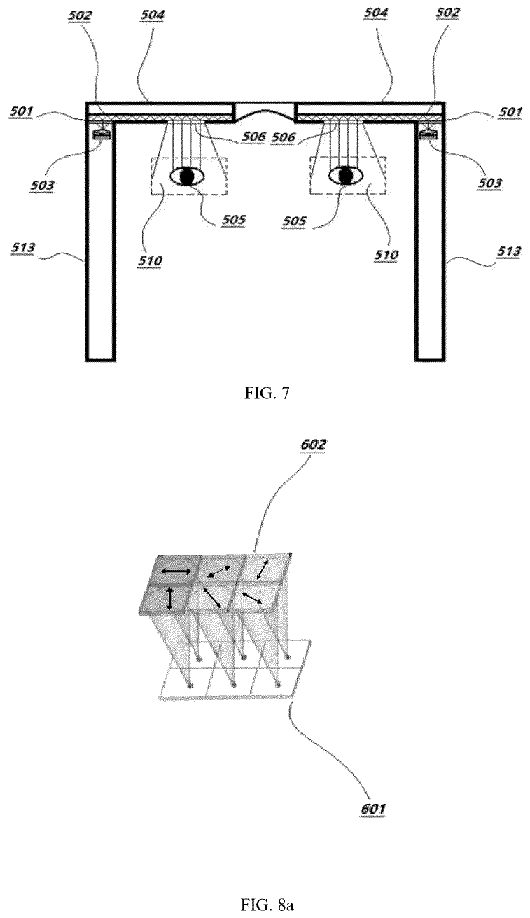

For a further example, in the AR form head-mounted display according to a specific example of the embodiments of the present application, as shown in FIG. 7, the eye/iris imaging optical unit is mounted at a position inside a spectacle frame 513, and the optical path of the eye/iris imaging optical unit transmits the near-infrared light emitted from the eye/iris through the reverse optical reflection conversion of an imaging optical path of an optical waveguide lens. Within the region of the field of view for imaging FOVi 510, of the eye/iris imaging optical unit, the near-infrared light emitted from the eye/iris 505 is coupled into an interior of an optical waveguide 502 by means of optical waveguide optical in-coupling (in-coupler) 506 and is transmitted to an optical waveguide optical out-coupling (out-coupler) 501 to the eye/iris imaging optical unit 503 by means of total reflection, thereby completing the whole optical path imaging process. An important characteristic of the above-described optical path is: the imaging incident angle θi is constant at 0, i.e. a complete ideal front view (coaxial/on-axis).

In some examples, the configuration of the eye/iris imaging optical unit 503 includes, but not limited to, a telephoto imaging telescope combined optical system, and a focal length ratio −f1/f2=angular magnification=1/β=1/(−PR*PS) of front and behind lenses (defined according to the optical path propagation orientation).

In application of forward optical/optical path conversion with the equivalent principle, the near-infrared illumination optical unit 513 is mounted at various positions relative to the eye/iris imaging optical unit. In some examples, the related position may be a peripheral edge of the image display source, and an emergent optical path of the image display source is multiplexed. The optical path of the near-infrared illumination optical unit transmits near-infrared light to the eye/iris by means of the forward optical reflection conversion of the imaging optical path of the optical waveguide, and the near-infrared light emitted by the near-infrared illumination optical unit is coupled into the 502 by means of the in-coupling 501 and is propagated into the out-coupling 506 to reach the region of field of view for illumination, FOVr, of the human eye 505, thereby completing the whole optical path illumination process. One important characteristic of the above-described optical path is: the illumination angle of emergence θr is constant at 0, which results in the introduction of a red eye effect to reduce the contrast of a pupil region. The modification method includes, not limited to: shifting an angle of emergence, adjusting an angle of emergence orientation, etc., and the condition that θr>7 degrees is satisfied.

As shown in the above example, the near-infrared illumination optical unit is arranged corresponding to the eye/iris imaging optical unit. It should be specially noted that the position of the near-infrared illumination optical unit should be considered to avoid the emergent light from being focused and guided to a user's retina by a crystalline lens, and avoiding occurrence of thermal and retinal radiation damage.

In some examples, for different types of optical waveguides, optical in-coupling/optical out-coupling optical elements may include, but not limited to, a surface-relief grating waveguide, a volume holographic grating waveguide, geometric arrays of optical waveguide etc. are of different types by means of specific orientational circular polarization and/or diffraction level in-coupling/out-coupling combinations. Due to the limitation of the total internal reflection TIR angle of the optical waveguide, the incident angle/diffraction angle of the optical waveguide used for FOV of illumination and imaging are also limited. The metasurface optical element (meta-coupler) with phase modulation technology (above-described incident angle/angle of emergence conversion) is provided with an tunable sub-wavelength spatial nanostructure, the meta-coupler tunes

an incident angle/angle of emergence conversion to coupling in/out a TIR angle of an optical waveguide within a predetermined FOV of illumination and imaging. Such that the degree of freedom of incident angle/angle of emergence has the advantage over the incident/diffraction angle corresponding to a diffractive optical element.

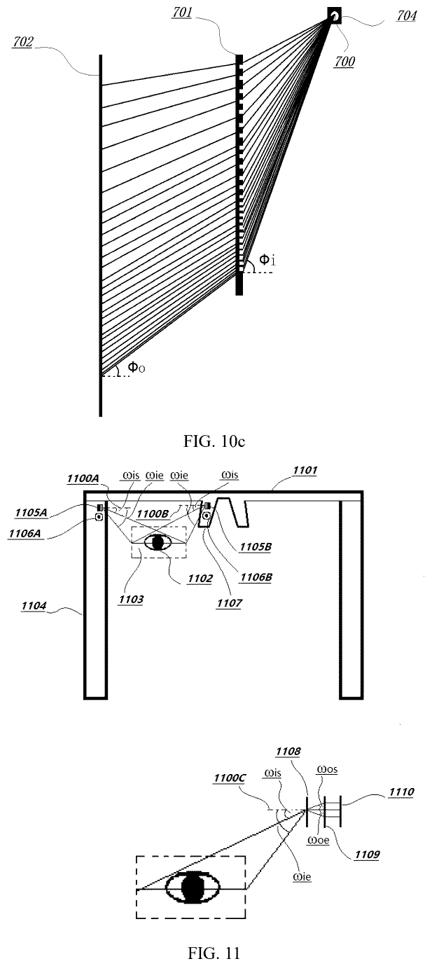

In some embodiments with equivalent variations, while maintaining consistency with the principles of other embodiments, as shown in FIG. 11, the eye imaging optical unit and illumination optical unit of a head-mounted device (e.g., AI/AR glasses 1101) may be subject to size constraints requiring dimensions below 2 mm×2 mm×2 mm. Due to the compact form factor requirements of the HMD (e.g., AI/AR glasses 1101), which involve spatially complex and variable structural layout designs, the eye/iris imaging optical units 1105A, 1105B may be configured in off-axis arrangements and mounted at diverse spatial positions and orientations, such as those defined by the temple arms 1104 and/or the nose pad bracket 1108.

In embodiments, at least one or more eye/iris imaging optical units 1105A, 1105B are configured according to the application scenario, with corresponding off-axis layouts installed in at least one or more spatial positions and orientations. Similarly, in embodiments, at least one or more eye/iris illumination optical units 1106A, 1106B are configured according to the application scenario, with corresponding off-axis layouts installed in at least one or more spatial positions and orientations.

The imaging field of view (FOVi) of the eye/iris imaging optical unit corresponding to the predetermined imaging region 1103 (RXi, RYi), including its horizontal (FOVxi) and vertical (FOVyi) components, is determined by the spatial mounting position of the associated off-axis layout.

The predetermined tilting angle of the principal optical axis 1100A, 1100B, 1100C of the eye/iris imaging optical unit corresponding to the predetermined imaging region 1103 (RXi, RYi) is determined by the spatial orientation of the associated off-axis mounting configuration.

In a preferred embodiment, for illustrative simplicity in FIG. 11, the spatial orientation of the predetermined tilt angle serves as the principal optical axis 1100A, 1100B, 1100C are parallel to the predetermined imaging region 1103 (object plane).

For case of subsequent description, the abbreviated terms AOI (angle of incidence) and AOE (angle of emergence) may be adopted where appropriate.

The range of AOI/AOE (ωi/ωo) for the eye/iris imaging optical unit corresponding to the predetermined FOVi is determined by the principal optical axis of the eye/iris imaging optical unit at the predetermined tilt angle, which serves as the normal axis of the symmetry center.

In other words, the angular range of AOI/AOE (ωi/ωo) is determined by the angular relationship between the principal optical axis of the eye/iris imaging optical unit at the predetermined tilt angle, serving as the normal axis of the symmetry center, and the predetermined imaging field of view (FOVi).

For a better understanding of the corresponding angular ranges of AOI/AOE (ωi/ωo), please refer to the ranges illustrated in FIG. 11:

ωi∈[ωis, ωie] and ωo∈[ωos, ωoe].

ωis and ωie represent the boundary range of AOI.

ωos and ωoe represent the boundary range of AOE.

In some embodiments, by configuring different predetermined tilt angles for the principal optical axis, serving as the normal axis at the center of symmetry, of the eye/iris imaging optical unit relative to the predetermined FOVi, variable ranges of off-axis AOI may be achieved. Some examples of angular ranges for off-axis AOI include but are not limited to: ωi∈[0, FOVi], ωi∈[90−FOVi, 90].

In some embodiments, consistent with other embodiments, the metasurface optical element (meta-converter 1108), which manipulates the angular conversion of the AOI/AOE (ωi/ωo) for the eye/iris imaging optical unit, performs the angular conversion relation of the wavefront phase modulation function φ (phase gradient φ′). However, as described in other embodiments, the higher-order nonlinear angular conversion relation of the wavefront phase modulation function may lead to increased fabrication complexity of the metasurface optical element (meta-converter) and potentially introduce imaging aberrations (focusing) when operating in the joint imaging mode.

As described in other embodiments, the angular conversion relation of the wavefront phase modulation function φ (phase gradient φ′) in the metasurface optical element (meta-converter) may be further simplified into an approximate low-order angular conversion relation. In some embodiments, it may be configured as a first-order angular conversion relation with corresponding optical characteristics, while maintaining optical conjugate properties.

By manipulating the wavefront phase modulation function (Φ) of the metasurface optical element (meta-converter), a specific phase profile distribution is configured, characterized by the gradient of the wavefront phase modulation function (phase gradient Φ′). The principal optical axis of the eye/iris imaging optical unit is configured as the normal axis of the symmetry center for the metasurface optical element (meta-converter).

An example illustrates the wavefront phase modulation function Φ (phase gradient Φ′) of the meta-converter, which has optical characteristics of a specific first-order angular conversion relation, is characterized by:

$${Φ}^{′} = - {n}_{i} \cdot k \cdot [ ( sin ( ω is ) + sin ( ω ie ) ) / 2 ]$$

where, k=2π/λ is the wavenumber, λ is the imaging wavelength, nᵢ is the refractive index of the incident medium (typically air).

The metasurface optical element (meta-converter) establishes a bijective mapping between AOI and AOE.

The metasurface optical element (meta-converter) manipulates the angular conversion relation between the AOI and the AOE (ωi/ωo), with optical characteristics characterized by:

$$sin {ω}_{o} = ( {n}_{i} / {n}_{o} ) \cdot [ sin {ω}_{i} - ( sin ( ω is ) + sin ( ω {i}_{e} ) ) / 2 ]$$

where, nₒ is the refractive index of the emergent medium (typically air or a relay optical medium), nᵢ is the refractive index of the incident medium.

In this example, the angular conversion characteristics between ωi and ωo have optical conjugate properties.

The metasurface optical element (meta-converter) manipulates the angular conversion such that when ωi couples into the boundary of the AOI (ωis/ωie), the corresponding boundary of the AOE (ωos/ωoe) for ωo is:

$$sin ω os = - {n}_{i} / {n}_{o} \cdot [ ( sin ( ω ie ) - sin ( ω is ) ) / 2 ]$$

$$sin ω oe = + {n}_{i} / {n}_{o} \cdot [ ( sin ( ω ie ) - sin ( ω is ) ) / 2 ]$$

This demonstrates that when ωi couples into the boundary of the AOI (ωis/ωie), the converted AOE (ωos/ωoe) satisfies ωos=−ωoe, exhibiting perfectly centrosymmetric optical characteristics relative to the principal optical axis of the imaging optical unit.

In specific examples, such as FOVi=60 degrees and ni/no=1.0, based on the predetermined imaging field of view (FOVi) and configuring the principal optical axis of the eye/iris imaging optical unit to serve as the normal axis (the center of symmetry) at different predetermined tilt angles, variable ranges of off-axis AOI may be achieved. For instance:

$$ω i ∈ [ 0 , 60 ] ,$$

$$ω i ∈ [ 20 , 80 ] ,$$

$$or$$

$$ω i ∈ [ 30 , 90 ] .$$

When the AOI ωᵢ is coupled into the boundary, the angular conversion couples out the corresponding AOE ωo, with examples including:

$$ω o ∈ [ - 25.66 , + 25. 66 ] ,$$

$$ω o ∈ [ - 18.75 , + 18. 75 ] ,$$

$$ω o ∈ [ - 14 \text{.5} , + 14. 5 ] .$$

The above examples are merely illustrative explanations of the underlying principles and do not constitute exclusive limitations. Different variants with equivalent generalized principles may exist and be implemented.

Through angular conversion of the AOI/AOE beam, the eye/iris imaging optical unit may effectively perform an inverse transformation of the off-axis imaging effect's optical characteristics. By controlling the emergent beam to approximate the physical characteristics of coaxial geometric optical imaging, it substantially improves key optical parameters, including imaging region perspective and field-of-view distortion.

Furthermore, the angular range of AOE has:

(1) centrosymmetric optical characteristics relative to the principal optical axis of the imaging optical unit,

(2) optical conjugate properties,

(3) optical compression of angular range, where the angular range of AOE is less than or equal to the angular range of AOI.

In the optical path, the angular range of AOE from the meta-converter 1108 may be optically relayed to serve as the FOV for the metalens 1109. This configuration significantly facilitates subsequent optimization of the focusing optical path, thereby enhancing the overall optical performance of the imaging system. The spatial resolution (MTF) at the focal plane of the imaging system is strongly dependent on the incident angular range.

Consistent with the description in FIG. 10b, FIG. 11 illustrates that for the joint imaging mode, on the optical path, the meta-converter 1108 is configured to manipulate the AOI/AOE conversion. The angular range of AOE is optically relayed to serve as the imaging field of view (FOVi) for the metalens 1109.

The metalens 1109 is configured to focus onto the image plane of the image sensor 1110 using the joint imaging mode.

In some embodiments for the joint imaging mode, the metalens 1109 is configured to manipulate the AOI/AOE to focus onto the image plane of the image sensor 1110 in an image-space near-telecentric configuration, and the meta-converter 1108 serves as the aperture stop for the metalens 1109.

By utilizing the characteristic that the aperture stop is located at the front focal plane of the metalens 1109, nearly telecentric imaging within the incident field-of-view angle is configured, and off-axis aberrations are manipulated through physical spatial separation (such as air gaps or optical media).

FIG. 18 (left) shows a partial SEM pattern of the subwavelength meta-atom nanostructures of the metalens 1109.

In other embodiments for the joint imaging mode, the metalens 1109 is configured with a wavefront phase modulation function (phase profile distribution) featuring a quadratic phase profile to provide virtual aperture stop functionality.

In other examples, the predetermined angular-conversion optical element includes, but is not limited to, a metasurface-based meta-converter. Other types, such as diffractive optical elements (DOE), may perform the angular-conversion relation (i.e., AOI to AOE by the diffraction grating equation) corresponding to a specific wavefront phase profile function by configuring parameters such as diffraction orders, periodic feature sizes, and phase orders.

In some other equivalent embodiments, the imaging lens includes, but is not limited to, the metalens. WLO imaging lenses are manufactured using standard WLO semiconductor processes such as etching/photolithography, imprinting, embedding, UV curing, dicing, and packaging applied to various optical semiconductor materials. WLO imaging lenses may still be preferentially selected for equivalent implementation.

Critical evaluation is required for the optical compression characteristics of the angular range of AOE in the meta-converter 1108, involving trade-off analysis with:

(i) the physical spatial separation (e.g., air gap or optical medium) between the meta-converter and metalens, or

(ii) the focal length extension of a WLO imaging lens, to minimize system thickness while maintaining optimal optical performance.

Consistent with other embodiments described, the eye/iris imaging optical unit may be configured with an optical filter to block stray beam interference from non-imaging wavelengths, thereby improving the optical signal-to-noise ratio (SNRo).

Similarly, consistent with other embodiments, the eye/iris imaging optical unit and the near-infrared illumination optical unit may be configured for orthogonal polarization-state imaging to filter stray beam interference (whether at imaging or non-imaging wavelengths), thus enhancing the SNRo.

The above examples are merely illustrative explanations of the underlying principles and do not constitute exclusive limitations. Different variants with equivalent generalized principles may exist and be implemented.

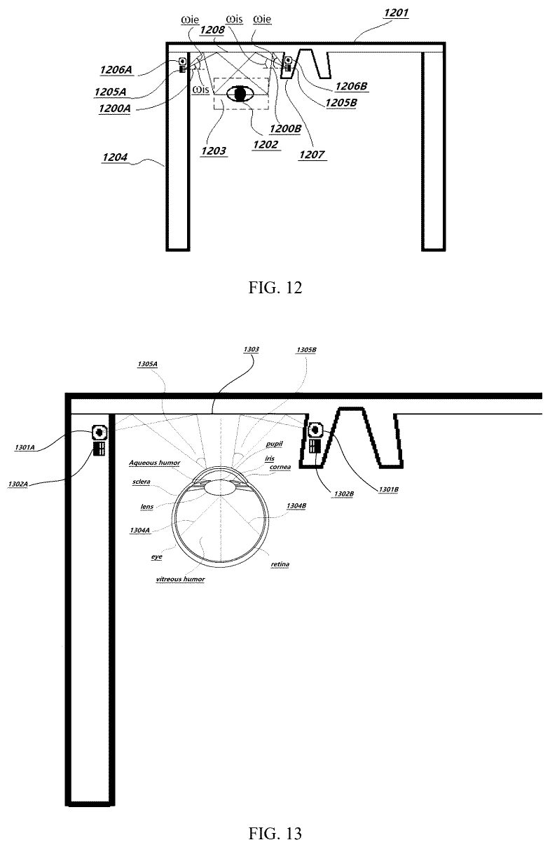

FIG. 12 illustrates a head-mounted device (e.g., AI/AR glasses 1201) in some equivalent variant embodiments, consistent with the principles of other embodiments. The labeled components include:
Eye 1202,
Predetermined imaging region 1203,
Temple 1204,
Eye/iris imaging optical unit 1205A, 1205B,
Illumination optical unit 1206A, 1206B,
Nose pad support 1207,
principal optical axis of imaging unit 1200A, 1200B, and
AR lens optical reflective coating 1208.

The distinction between the embodiments of FIG. 12 and FIG. 11 lies in the transition from direct imaging to indirect imaging. The eye/iris imaging optical units 1205A, 1205B capture near-infrared (NIR) beam emitted from the predetermined imaging region 1203, which is then reflected by the AR lens optical reflective coating 1208 to form the imaging optical path.

In some embodiments, the AR lens optical reflective coating 1208 may be deposited on or laminated to different optical surfaces. In some examples, such optical surfaces may include, but are not limited to, partial or full surfaces of optical components (e.g., optical waveguides).

The optical reflective coating 1208 may employ a thin-film interference deposition technique, exhibiting:
High reflectivity in the near-infrared (NIR) band for indirect imaging by the eye/iris imaging optical units 1205A, 1205B;
High transmittance in the visible band to enable optical see-through of the world-side scene for the human eye 1202.

Additionally, the AR reflective coating 1208 may reflect a significant portion of non-imaging NIR stray beam from the world-side scene, thereby blocking direct forward-propagating beam (within the imaging field-of-view angle, AOI) from entering the eye/iris imaging units. This mechanism enhances the optical signal-to-noise ratio (SNRo) of the imaging system.

In alternative embodiments, the AR reflective coating 1208 may be configured as a reflective holographic optical element (rHOE) film, fabricated through interference exposure technology to perform:

Wavelength-and AOI-dependent selectivity, reflecting NIR beam for indirect imaging while transmitting visible beam for optical see-through of the world-side scene by the human eye 1202;

The diffraction angle design of the rHOE (by the holographic diffraction grating equation) for AOI from the predetermined imaging region 1203 satisfies the prescribed angular range [ωi, ωiₑ].

For planar-type AR lenses (e.g., waveguides) combined with diopter-corrective lenses, after passing through the folded reflection/refraction optical path, the AOI/AOE still obey the laws of optical reflection.

The same principle applies to illumination/imaging optical paths.

The remaining descriptions in FIG. 12 may reference FIG. 11's embodiment under equivalent principles, including the metasurface optical element (meta-converter) that manipulates the AOI/AOE (ωᵢ/ωₒ) of the eye/iris imaging optical units 1205A, 1205B.

For those skilled in the art, this configuration should be self-explanatory without redundant description.

The present disclosure describes the biometric system for retinal illumination and imaging in head-mounted devices. When applied to AR glasses, in such embodiments the volumetric constraints of the retinal imaging optics and illumination optics may require dimensions below 2 mm×2 mm×2 mm. It is evident that conventional retinal illumination and imaging configurations, such as eyepiece objectives or other traditional optical arrangements, cannot be implemented in such applications.

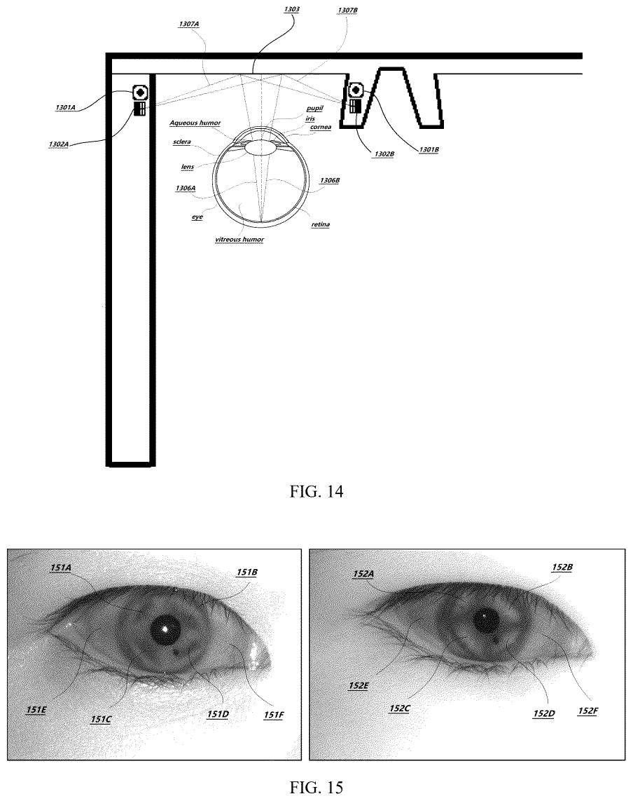

The present disclosure describes a biometric system for retinal illumination and imaging in head-mounted devices. In some embodiments, as illustrated in FIGS. 13 and 14, the retinal illumination optical unit 1301A, 1301B projects illumination emergent beam 1305A, 1305B that is reflected through the AR lens optical reflective coating 1303. The emergent beam converges at a predetermined corneal edge to enter the eye.

The beam undergoes refraction through the anterior segment structures (cornea and aqueous humor) to form an entrance pupil at the pupillary plane. After further refraction by the posterior segment structures (lens and vitreous body), the beam diverges to form the retinal incident beam 1304A, 1304B. Upon reaching the retina, the beam interacts with photoreceptor cells, macula, optic disc, and choroidal blood vessels through absorption, diffuse reflection, and scattering, thereby forming the retinal reflected beam 1306A, 1306B.

The retinal reflected beam is refracted by the lens/cornea and exits the pupil through the pupillary plane as the imaging incident beam 1307A, 1307B. The imaging incident beam propagates to the AR lens optical reflective coating 1303, where it is reflected and redirected into the retinal imaging optical unit 1302A, 1302B to implement the integrated retinal illumination and imaging optical path.

In some embodiments, the AR lens optical reflective coating 1303 may be deposited on or laminated to different optical surfaces. In some examples, such optical surfaces may include, but are not limited to, partial or full surfaces of optical components (e.g., optical waveguides).

The optical reflective coating 1303 may employ a thin-film interference deposition technique, exhibiting high reflectivity in the near-infrared (NIR) band for redirected illumination/imaging by the retinal illumination optical unit 1301A, 1301B and retinal imaging optical unit 1302A, 1302B.

Additionally, the AR reflective coating 1303 may reflect a significant portion of non-imaging NIR stray beam from the world-side scene, thereby blocking the direct forward-propagating beam (within the imaging field-of-view angle, AOI) from entering the retinal imaging optical unit. This mechanism enhances the optical signal-to-noise ratio (SNRo) of the imaging system.

In alternative embodiments, the AR reflective coating 1303 may be configured as a reflective holographic optical element (rHOE) film, fabricated by means of interference exposure technology to perform wavelength-and AOI-dependent selectivity, reflecting NIR beam for redirected illumination/imaging.

The diffraction angle design of the rHOE (by the holographic diffraction grating equation) satisfies the predetermined illumination emergent beam 1305A, 1305B and imaging incident beam 1307A, 1307B.

The retinal illumination optical unit 1301A, 1301B projects the illumination emergent beam 1305A, 1305B, reflected by the AR lens optical reflective coating 1303, in a predetermined off-axis oblique illumination angle, converging at the corneal periphery. This configuration facilitates optimized suppression of stray beam reflections from the corneal surface.

A wider angle of the illumination emergent beam facilitates an expanded retinal illumination/imaging field of view (FOV), while a narrower angle of the illumination emergent beam reduces optical reflections from intraocular tissues to enhance contrast in localized retinal regions.

In some embodiments, the retinal illumination/imaging field of view (FOV) may be extended.

In embodiments, at least one retinal imaging optical unit is configured according to the application scenario, with corresponding off-axis layout installed in at least one spatial position and orientation. Similarly, in embodiments, one or more retinal illumination optical units are configured according to the application scenario, with corresponding off-axis layouts installed in one or more spatial positions and orientations, and selectively activated via addressable asynchronous switching to enable one or a combination thereof.

The pupillary plane separates the illumination and imaging optical paths through an optical entrance pupil and exit pupil and may be configured with optical conjugate properties.

In some embodiments, the retinal imaging optical unit may be configured as a composite imaging optical system including, but not limited to:
a first lens (defined as front lens along the optical path propagation direction),
a second lens (defined as rear lens along the optical path propagation direction), and an image sensor,
wherein the focal length ratio of the first (front) and second (rear) lenses satisfies −f₁/f₂=angular magnification=1/β=1/(−PR×PS).

In some embodiments, the first (front) lens and second (rear) lens may be configured as metalens or WLO imaging lens, with the optical path arranged in a predetermined spatial separation (e.g., an air gap) between the first and second lenses to achieve volume compression.

The present disclosure relates to a biometric system for retinal illumination and imaging in head-mounted devices. In some waveguide-based embodiments, as shown in FIG. 16:

The retinal illumination optical unit 1602 emits a beam collimated by an optical collimator 1604 to form a predetermined aperture beam.

The collimated beam is combined through an optical beam splitter 1603 into a collimated emergent beam, which enters an optical input coupler (1606, reverse optical path) at a total internal reflection (TIR) angle to couple into the optical waveguide 1605.

The beam propagates through TIR to an optical output coupler (1607, reverse optical path), where it couples out at a predetermined AOE, forming projected illumination emergent beams 1608A/1608B/1608C that converge at a predetermined corneal edge.

The emergent beam undergoes refraction through the anterior segment structures (cornea and aqueous humor) to form an entrance pupil at the pupillary plane. After further refraction by the posterior segment structures (lens and vitreous body), the beam diverges to form a retinal incident beam. Upon reaching the retina, the beam interacts with photoreceptor cells, macula, optic disc, and choroidal blood vessels through absorption, diffuse reflection, and scattering, thereby forming a retinal reflected beam.

The retinal reflected beam is refracted by the lens/cornea and exits the pupil through the pupillary plane as imaging incident beams 1609A/1609B/1609C.

The imaging incident beam propagates to the optical input coupler (1607, forward optical path), coupling into the optical waveguide at a TIR angle and transmitting through TIR to the optical output coupler (1606, forward optical path), where it is coupled out to the optical beam splitter 1603.

Finally, the imaging incident beam is split by the optical beam splitter and redirected into the retinal imaging optical unit 1601, implementing the integrated retinal illumination and imaging optical path.

In some embodiments, the retinal imaging optical unit may be configured as a compound imaging optical system including, but not limited to
a first lens (defined as front lens along the optical path propagation direction),
a second lens (defined as rear lens along the optical path propagation direction), and an image sensor,
wherein the focal length ratio of the first (front) and second (rear) lenses satisfies −f₁/f₂=the angular magnification=1/β=1/(−PR×PS).

In some embodiments, the first (front) lens and second (rear) lens may be configured as metalens or WLO imaging lens, with the optical path arranged in a predetermined spatial separation (e.g., an air gap) between the first and second lenses to achieve volume compression.

In some embodiments, for retinal object/image points, the retinal imaging optical unit and retinal illumination optical unit may be configured with optical conjugate properties by splitting the illumination and imaging paths through a coaxial optical beam splitter 1603.

In other embodiments, the optical beam splitter may be removed, with the retinal imaging optical unit and the retinal illumination optical unit spatially offset from each other to achieve separate imaging and illumination.

The pupillary plane separates the illumination and imaging optical paths through the entrance pupil and exit pupil, and may be configured with optical conjugate properties.

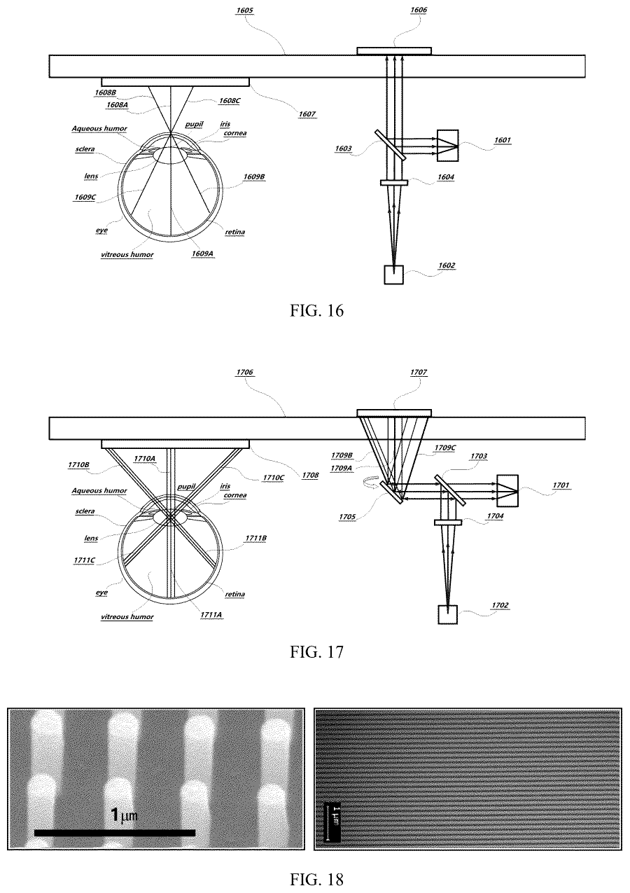

The present disclosure describes a biometric system for retinal illumination and imaging in a head-mounted device. In some embodiments based on optical path scanning, as shown in FIG. 17, the retinal illumination optical unit 1702 is collimated by an optical collimator 1704 into a beam with a predetermined aperture. The beam is then combined through an optical beam splitter 1703 and directed to a tunable beam steerer 1705, which angular deflects the reflected beam 1709A/1709B/1709C into an optical input coupler (1707, reverse optical path). The beam is coupled into the optical waveguide 1706 at a total internal reflection (TIR) angle and propagates through TIR to an optical output coupler (1708, reverse optical path), where it couples out emergent beam 1710A/1710B/1710C at a predetermined optical path scan.

The emergent beam undergoes refraction through the anterior segment structures (cornea and aqueous humor) to form an entrance pupil at the pupillary plane. After further refraction by the posterior segment structures (lens and vitreous body), the beam diverges to form retinal incident beam. Upon reaching the retina, the beam interacts with photoreceptor cells, macula, optic disc, and choroidal blood vessels through absorption, diffuse reflection, and scattering, thereby forming the retinal reflected beam.

The retinal reflected beam is refracted by the lens and cornea, forming imaging incident beam 1711A/1711B/1711C that exits pupil at the pupillary plane.

The imaging incident beam propagates to the optical input coupler (1708, forward optical path), coupling into the optical waveguide 1706 at a TIR angle and transmitting through TIR to the optical output coupler (1707, forward optical path), where it is coupled out to a synchronized tunable beam steering for angular deflection.

Finally, the imaging incident beam is split by the optical beam splitter 1703, and redirected into the retinal imaging optical unit 1701, implementing the integrated retinal illumination and imaging optical path.

In some embodiments, for retinal object/image points, the retinal imaging optical unit and retinal illumination optical unit may be configured with optical conjugate properties by splitting the illumination and imaging paths through a coaxial optical beam splitter 1703.

In other embodiments, the optical beam splitter may be removed, with the retinal imaging optical unit and the retinal illumination optical unit spatially offset from each other to achieve separate imaging and illumination.

The pupillary plane separates the illumination and imaging optical paths through the entrance pupil and exit pupil, and may be configured with optical conjugate properties.

In some embodiments, the optical collimator 1704 may be configured as optical components including but not limited to wafer-level optics (WLO) collimating lenses or metasurface collimating lenses. In some embodiments, the tunable beam steerer 1705 may be implemented using angle-tunable optical elements based on digital micromirror devices (DMD), micro-electromechanical systems (MEMS), liquid crystal spatial light modulators (LC-SLM), or phase-change material metasurface.

When the tunable beam steerer performs angular deflection, the corresponding optical scanning path follows synchronously. The beam steerer may be configured with predetermined high-resolution optical scanning accuracy, where its angular resolution per scanning step corresponds to the spatial angular resolution of retinal imaging.

In some embodiments, the retinal imaging optical unit 1701 is configured as a compound imaging optical system including, but not limited to: a first lens (defined as the front lens along the optical path propagation direction), a second lens (defined as the rear lens along the optical path propagation direction), and an image sensor, wherein the focal length ratio of the first (front) and second (rear) lenses satisfies −f₁/f₂=the angular magnification=1/β=1/(−PR×PS).

In some embodiments, the first (front) lens and second (rear) lens may be configured as metalens or WLO imaging lens, with the optical path arranged in a predetermined spatial separation (e.g., an air gap) between the first and second lenses to achieve volume compression.

The retinal illumination optical unit 1702 forms an illumination area of predetermined aperture at the retinal focal plane. This illumination area of predetermined aperture is simultaneously imaged and focused onto the photoelectric sensor (e.g., photodiode PD, single-photon avalanche diode SPAD, etc.) through the coaxial/on-axis retinal imaging optical unit 1701, effectively suppressing stray light from non-focal planes entering the photoelectric sensor and improving imaging contrast.

In some exemplary embodiments, optical-grade silicon carbide (SIC) material is employed as the high-refractive-index substrate for optical waveguides, reducing the total internal reflection (TIR) critical angle of the waveguides, thereby enhancing both the field-of-view (FOV) angle and coverage area for retinal illumination and imaging.

Compared to iris imaging, in retinal imaging applications, some embodiments may configure the pixel resolution (PR) to exceed 100 pixels/mm, 200 pixels/mm, or higher to acquire higher-resolution retinal images. Correspondingly, the modulation transfer function (MTFo) requires proportional adaptation. However, increased PR amplifies eye motion blur artifacts. Even during fixation, involuntary physiological movements, including microsaccades, tremors, and drifts, can degrade image quality.

Consistent with other embodiments, the polarized eye illumination/imaging optics can be configured to define a predetermined pixel shift amount in the image plane during the illumination/imaging exposure period under predetermined eye rotational angular velocity conditions. Based on the eyeball radius Reye and the eye's rotational angular velocity Ω, the illumination/imaging exposure period TI/TF is constrained to satisfy the predetermined pixel shift amount MP.

2*3.14*Reye*Ω/2π*TI<MP/PR

Reye denotes the radius of the eyeball, with a mean value of 12 mm, Ω represents the predetermined angular velocity of eyeball rotation, measured in radians per second (rad/s).

In some exemplary implementations, the maximum permissible pixel displacement (MP) may be configured at 1-pixel shift precision to maintain subpixel-level motion control accuracy, though this configuration is non-limiting and may be adjusted as required.

As described in other embodiments, in some embodiments, the fixation system is further configured to guide fixation targets. For head-mounted devices such as AR glasses, the fixation system may project a predetermined pattern onto the user's eyes through an AR display assembly (e.g., image display source, optical waveguide, and input/output couplers) with a predetermined focal image distance (i.e., the focused distance of virtual images in the user's eyes, such as 3, 5 m, or beyond). This projection establishes the predetermined pattern as a guided fixation target, wherein the eye maintains fixation on the pattern with a stabilized state of retinal focal plane alignment.

The fixation system may be configured to perform real-time display feedback of adjustment prompts by computationally analyzing retinal imaging data and/or multiplexed eye-tracking (ET) imaging data. The prompt information includes, but is not limited to: XY-axis offset alignment of retinal position, Z-axis movement of retinal distance, pupil dilation degree, retinal obstruction (by eyelashes, eyelids, or blinking), as well as fixation changes (such as Pitch/Roll/Yaw orientations).

In some other embodiments, the fixation system may further be configured to display iris imaging data and/or multiplexed eye-tracking (ET) imaging data in real time.

In these embodiments, the fixation system is configured via the imaging control unit according to predetermined parameters (e.g., based on individualized optometry parameters) to:

(a) render the predefined fixation pattern in real time;

(b) analyze imaging data of the retina/eye; and

(c) generate adjustment prompts to guide fixation targets through an operational sequence.

In other embodiments, the fixation system may additionally incorporate gaze-direction modulation to guide adjustments of the eye's visual axis, thereby enabling further expansion of the retinal illumination/imaging field-of-view (FOV) to capture peripheral retinal regions.

A multi-point positional and/or directional fixation system can guide focal points for targeted illumination and imaging of peripheral retinal vasculature.

In some embodiments, autofocus optical elements (e.g., MEMS-based, liquid crystal, or fluidic refractive optics) may be configured to compensate for diopter variations across populations, typically covering a correction range of approximately ±10 D. However, such configurations impose stringent constraints on the form factor and weight budget of AR eyewear systems.

In some embodiments of head-mounted devices (e.g., AR glasses), the retinal imaging optical unit incorporates individualized corrective prescription lenses (optionally bonded to the eye-facing side of the waveguide) to achieve:

refractive correction across diverse populations, and

fixation guidance via predetermined patterns from the fixation system.

The retinal object plane is configured with fixed optical conjugacy relative to the focal plane of the imaging optical unit, thereby eliminating the need for autofocus components, a critical advantage for AR glasses with stringent size and weight constraints.

Although near-infrared (NIR) light exhibits multi-fold higher reflectance than visible light, deeper tissue penetration, and enables non-mydriatic operation of fixation systems at these wavelengths, as known to those skilled in the art, the visible spectrum provides higher background contrast due to differential absorption by: photoreceptors, retinal arterioles/venules, and macular optic disc structures.

Thus, some embodiments may configure multi-spectral illumination and imaging across visible-NIR wavelengths.

Consistent with other described embodiments, the retinal imaging optical unit and retinal illumination optical unit are configured with orthogonal polarization states for illumination and imaging, thereby eliminating imaging artifacts from corneal surface reflections and intra-lens (crystalline) backscattering.

The orthogonal polarization state enhances the optical signal-to-noise ratio (SNRo).

Next, several variant embodiments based on polarized eye illumination/imaging optical units are introduced for dynamic qualitative/quantitative monitoring and analysis of physiological states, maintaining consistency with the descriptions in other embodiments.

In some embodiments, the biometric system comprises:

the illumination optical unit is configured to emit light with at least one of a polarization state to the eye; the imaging optical unit is configured to capture an image using the image sensor that is sensitive to at least one of a corresponding polarization state; the imaging control unit is configured to generate at least one of an identical and orthogonal polarization state combination, synchronize timing and process a polarization intensity data from the image.

In accordance with some implementations, the polarization intensity data is configured with at least one of a pattern modality of corneal polarization interference intensity or a pattern modality of scleral polarization scattering intensity serving as a cross-reference feature for characterizing an eye physiological state.

In some embodiments, the polarized eye illumination/imaging optical unit is configured with linear/chiral circular-polarization-sensitive optical metamaterials (e.g., helical chiral circular-polarization-sensitive metamaterials) or metasurface polarization gratings, featuring:
Extinction ratio >100:1, 1000:1, or higher;
Transmittance >50%, 60%, 70%, 80%, 90%, or higher.

In other embodiments, the pixelated polarization orientation of the polarized eye illumination/imaging optical unit may be stabilized via metasurface grating structures fabricated by etching, with subwavelength grating periods (e.g., approximately 120-180 nm in some examples) and etching depths of about 60-80 nm. Such subwavelength metasurface grating structures may be mass-produced at high throughput and low cost using nanoimprint lithography.

FIG. 18(right) exemplifies a partial SEM (scanning electron microscopy) micrograph of the subwavelength metasurface grating structure with 0°-oriented polarization.

In some embodiments, a phase retarder is stacked on the metasurface grating linear polarizer (LP) layer, where the retarder comprises nanopillars (metal/dielectric meta-atoms) with a predetermined phase retardation along orthogonal directions. The fast/slow axes of the retarder are configured at +45°/−45° relative to the transmission axis of the metasurface grating to generate right-handed/left-handed circular polarization (RCP/LCP).

In some embodiments, a multi-polarization-state metasurface grating or linear/chiral circular-polarization-sensitive optical metamaterial may be stacked atop an image sensor layer.

In some embodiments, the polarized eye illumination/imaging optical unit may be configured using tunable liquid crystal (LC)/phase-change materials to achieve real-time, independently controllable polarization state switching. This tunability enhances polarization-state resolution.

The polarized eye illumination/imaging system (particularly RCP/LCP configurations) provides:

(a) Environmental stray light suppression-blocking complex ambient light including
Direct incident light (AOI)
Primary/secondary indirect reflections

(b) Ocular surface reflection mitigation—reducing interference from:
Eye surface contaminants (tears, secretions)
Periocular skin reflections (cosmetics, oils)

This enables the acquisition of high-quality polarization-state intensity images in eye image sequences.

Since natural environments exhibit negligible circular polarization (CP), compared to linear/partially linear polarization (LP), in most scenarios, some embodiments may adopt RCP/LCP configurations to:
Effectively eliminate ambient stray light in imaging
Enhance optical signal-to-noise ratio (SNRo) with improvements exceeding 20 dB in clinical tests.

### EXAMPLE 1

The imaging control unit configures the polarized eye imaging optical unit to form a 2×2 pixelated multi-polarization-state imaging array with 0°+90°+45°+135° orientations. Correspondingly, the polarized eye illumination optical unit is configured to operate in any one of 0°/90°, 45°/135°, or any combination thereof.

### EXAMPLE 2

The imaging control unit configures the polarized eye imaging optical unit to imaging array with form a 2×2 pixelated full-polarization-state 0°+90°+45°/135°+RCP/LCP orientations. Correspondingly, the polarized eye illumination optical unit is configured to operate in any one of 0°/90°, 45°/135°, RCP/LCP, or any combination thereof.

### EXAMPLE 3

The imaging control unit configures the polarized eye illumination optical unit to form a 2×2 switchable multi-polarization-state illumination array with 0°+90°+45°+135° orientations. Correspondingly, the polarized eye imaging optical unit is configured for pixelated polarization imaging in any one of 0°/90° or 45°/135° polarization state.

### EXAMPLE 4

The imaging control unit configures the polarized eye illumination optical unit to form a 2×2 switchable full-polarization-state illumination array with 0°+90°+45°/135°+RCP/LCP orientations. Correspondingly, the polarized eye imaging optical unit is configured for pixelated polarization imaging in any one of 0°/90°, 45°/135°, or RCP/LCP polarization state.

In some embodiments, the imaging control unit is configured to:
(i) Synchronize the timing of:
   optical radiation from the polarized eye illumination optical unit, and
   the exposure (integration) periods of the polarized eye imaging optical unit.
(ii) establish addressable encoding associations for each parallel (identical) and orthogonal polarization-state combination during illumination-imaging operations; and
(iii) selectively activate/deactivate specific polarization states through asynchronous switching.

The imaging control unit receives digitized polarization-intensity data (pixelated images) from the imaging optical sensor, generated from at least one configured combination of parallel (identical) and orthogonal polarization states.

In some embodiments, the polarization-intensity data (pixelated images) generated by parallel (identical, denoted as p) and orthogonal (denoted as s) polarization-state combination configurations for illumination and imaging are specifically defined as follows:
1. Independent Polarization State Set:
   {0°, 90°, 45°, 135°, RCP, LCP}
   2. Orthogonal Polarization-State Combination Set s:
   {(0°,90°), (45°,135°), (RCP,LCP)}
3. Parallel (Identical) Polarization-State Combination Set p:
   {(0°,0°), (45°,45°), (RCP,RCP)}
or equivalently:)
   {(90°,90°), (135°,135°), (LCP,LCP)}
4. Parallel+Orthogonal Combination Set p+s:
   {(0°,0°)+(0°,90°), (45°,45°)+(45°,135°), (RCP,RCP)+(RCP,LCP)};
or equivalently:
   {(90°,90°)+(0°,90°), (135°,135°)+(45°,135°), (LCP,LCP)+(RCP,LCP)};

The polarization-intensity data (pixelated images) corresponding to:
the parallel (identical) polarization-state combination set p is denoted as Ip;
the orthogonal polarization-state combination set s is denoted as Is.

In different embodiments, any subset of the above combination sets may be implemented.

The above configurations of parallel (identical) and orthogonal polarization-state combinations are presented for illustrative explanation of operational principles only, and are not intended to be exclusively limiting. Equivalent variants based on the same underlying principles may be realized and implemented.

The birefringence of the ocular cornea is a core aspect of its optical properties, arising from the highly ordered arrangement of collagen fibrils and the unique characteristics of the surrounding biological matrix.

The lamellar structure of corneal collagen fibrils is the primary source of optical anisotropy and birefringence. Their radially symmetric, circumferential alignment directly contributes to the observed biological birefringent effects.

The optical mechanisms underlying corneal birefringence include:
1. Angular rotation and phase retardation of incident light due to the curvature of the corneal surface.
2. Phase retardation caused by the circumferential angular orientation of birefringent collagen fibrils within the cornea.

The cornea behaves as a uniaxial birefringent medium, exhibiting refractive index differences along orthogonal polarization axes.

Light incident parallel or perpendicular to the corneal surface remains unaffected, while obliquely incident light undergoes polarization axis rotation and phase retardation. This is effectively equivalent to altering the angular relationship between the polarization direction and the fast/slow axes of the cornea.

In some embodiments, when the transmission axes of the polarized eye illumination optical unit and imaging optical unit are configured as either parallel (identical) or orthogonal, the birefringence of the corneal biotissue (determined by optical parameters such as birefringence index |nₒ−nₑ|, wavelength, and corneal thickness) induces a polarization interference effect.

This effect is characterized by the interference intensity between parallel (identical) and orthogonal polarization state, exhibiting approximately symmetric periodicity and manifesting as four phase-inverted maxima and minima. These properties are reflected in the characteristics of the imaging pattern modality, as illustrated in FIG. 15.

The parallel (identical) and orthogonal polarization state combination, configured as p+s, is: (0, 0)+(0, 90).

Relative to the parallel (identical) polarization-state combination subset p=(0,0) in the illumination/imaging configuration, within the imaging pattern modality, the regions 151A, 151B, 151C, and 151D show destructive interference, while the remaining regions show constructive interference.

Relative to the orthogonal polarization-state combination subset s−(0,90) in the illumination/imaging configuration, within the imaging pattern modality, the regions 152A, 152B, 152C, and 152D show constructive interference, while the remaining regions show destructive interference.

The pattern modality of corneal polarization interference intensity between parallel (identical) and orthogonal polarization state exhibiting polarity inversion may be characterized by a cross-reference feature and may serve as a corneal characteristic of the eye.

Despite non-uniform corneal thickness variations and inter-individual biological differences, the cross-reference feature of the corneal polarization interference intensity pattern corresponding to birefringence effects remains consistent within the same individual.

In some other embodiments, when applied to long-term health monitoring of individuals, dynamic qualitative/quantitative analysis of ocular physiological state may additionally include the scleral region. Within the scleral region, collagen and elastic fibers provide surface scattering of incident light from the polarized eye illumination optical unit through their disordered anisotropic distribution and vascular absorption characteristics. The scattered light may be detected by the polarized imaging optical unit.

The parallel (identical) and orthogonal polarization state combination, configured as p+s, is: (0, 0)+(0, 90).

Relative to the parallel (identical) polarization-state combination subset p=(0,0) of the illumination/imaging configuration, the imaging pattern modality shows the scattering pattern featuring 0° polarized (parallel) regions, indicated as 151E/151F.

Relative to the orthogonal polarization-state combination subset s=(0,90) of the illumination/imaging configuration, the imaging pattern modality shows the scattering pattern featuring 90° polarized (orthogonal) regions, indicated as 152E/152F.

The pattern modality of scleral polarization scattering intensity between parallel (identical) and orthogonal polarization states exhibiting polarity inversion may be characterized by a cross-reference feature and may serve as a scleral characteristic of the eye.

Multiple combined illumination-imaging configurations employing parallel (identical) and orthogonal polarization states generate corresponding imaging pattern modality reflecting either/both:
(i) corneal polarization interference intensity variations, and
(ii) scleral polarization scattering intensity variations, thereby providing cross-reference feature with enhanced accuracy and stability. In various embodiments, the aforementioned cross-reference feature data may be implemented in any subset of the combined configuration set.

From an information-theoretic perspective, the cross-referenced feature encoding of polarity inversion channels (identical and orthogonal polarization state) is capable of maximum entropy, simultaneous noise suppression (optical noise, electrical noise etc.) interference cancellation (motion artifacts, random polarized light etc.) and signal enhancement of the pattern modality (corneal polarization interference intensity and/or scleral polarization scattering intensity).

The imaging control unit, pre-trained via a lightweight machine/deep learning model (e.g., CNN, DNN, RNN, GNN, VIT) using a high-dimensional mapped cross-reference feature dataset of at least one or multiple polarization state combination configurations, including corneal polarization interference intensity pattern and/or scleral polarization scattering intensity pattern, is configured to perform end-to-end inference for predicting dynamic qualitative/quantitative monitoring and analysis of ocular physiological state.

Machine/deep learning models may learn intrinsic pattern modality of high-dimensional mappings that characterize eye physiological state through pre-training on cross-reference feature dataset of corneal polarization interference intensity pattern and/or scleral polarization scattering intensity pattern.

In some embodiments, data preparation generates a high-dimensional mapped dataset comprising cross-reference features derived from at least one or more combination configurations of parallel (identical) and orthogonal polarization states, along with their corresponding physiological states. The imaging control unit, after being pre-trained by inputting this high-dimensional mapped dataset through lightweight machine/deep learning models, performs end-to-end predictive inference to output dynamic qualitative/quantitative monitoring and analysis of ocular physiological states.

In some embodiments, the cross-reference features of corneal polarization interference intensity variation imaging patterns and/or scleral polarization scattering intensity variation imaging patterns may be defined based on manual feature extraction, such as differential feature (Ip−Is) or contrast features including but not limited to Is/(Ip+Is) and (Ip−Is)/(Ip+Is).

In some embodiments, the cross-reference features of corneal polarization interference intensity variation imaging patterns and/or scleral polarization scattering intensity variation imaging patterns may incorporate a dual-or multi-channel feature fusion unit within the deep learning model, where Ip and Is are respectively input into the feature fusion unit to perform autonomous high-dimensional feature extraction.

The Transformer model excels at modeling long-range dependencies, while feature fusion incorporates local details and multi-level visual information. The effective combination of both endows the model with global comprehension and local perception capabilities, significantly enhancing performance and generalizability while reducing computational costs.

The Transformer learns feature dependencies within image channels through channel-wise self-attention mechanisms, while incorporating a multi-scale feature extraction and fusion unit to effectively process global information with improved computational efficiency.

In some embodiments, the deep learning model is configured to incorporate a dual-/multi-channel feature disentanglement block within a Transformer-based VIT backbone network for direct disentangling of Ip and Is cross-reference feature. The feature disentanglement block enhances multi-scale spatial feature representation by disentangling Ip and Is cross-reference feature through dual/multi-channel processing, followed by global integration with original features. Utilizing cross-attention mechanisms for spatial relationship modeling of cross-reference features, the block performs spatial and cross-channel information disentangling via convolutional feedforward networks.

In some embodiments, a bidirectional spatiotemporal convolutional network architecture may be configured to simultaneously extract spatiotemporal features from both forward and reverse temporal sequences, while a self-attention mechanism is employed to highlight critical features based on the extracted spatiotemporal features.

In other embodiments, a Time-Difference Mamba (TD-Mamba) block may be incorporated with a dual-stream SlowFast architecture, wherein the model efficiently processes both short-term and long-range temporal features to enhance detection accuracy of dynamic variations in cross-reference features.

The aforementioned cross-reference feature extraction configurations are provided solely as exemplary illustrations of operational principles, and shall not be construed as exclusive or limiting. Variants embodying equivalent principles may be generalized and implemented without departing from the scope of this disclosure.

Since the Ip and Is images inherently encompass periocular regions, the corneal polarization interference intensity pattern occurs specifically in the transparent corneal zone, while its corresponding characterization is observed in the anatomically posterior iris region.

In some exemplary embodiments, the region of interest (ROI) for corneal polarization interference intensity pattern may be defined as the iris region, where at least one or multiple combined polarization configuration dataset of the corneal interference pattern ROIs are utilized during deep learning model training or inference.

In some embodiments, the corneal polarization interference intensity pattern may be localized within a region of interest (ROI), exemplified by detecting keypoints in the iris ROI from Is+Ip composite images while excluding invalid obstructions (e.g., eyelashes, eyelids, blink artifacts). The deep learning model may perform occlusion mask annotation during training and/or inference to suppress interference. In further embodiments, standardized normalization of the ROI compensates for precision errors induced by pupil dilation/constriction.

In some embodiments, the scleral polarization scattering intensity pattern may be localized within a scleral region of interest (ROI), as exemplified by detecting keypoints in the scleral ROI from Is+Ip composite images.

The exemplary deep learning model configurations described above, which are driven by cross-reference feature data derived from corneal polarization interference intensity patterns and/or scleral polarization scattering intensity patterns exhibiting polarity inversion between parallel (identical) and orthogonal polarization states, are provided solely as illustrative embodiments of the underlying principles and shall not be construed as limiting or exclusive. Various alternative implementations embodying equivalent principles may be generalized and practiced without departing from the scope of this disclosure.

In some embodiments, qualitative/quantitative monitoring based on corneal polarization interference intensity pattern and/or scleral polarization scattering intensity pattern enables longitudinal comparison of individual health status data variations.

During long-term health monitoring applications, the system initializes by establishing a historical health record archive for the individual.

When changes occur in an individual's ocular health status, such as keratoconus progression, intraocular pressure fluctuations, blood pressure variations, hemodynamic perfusion abnormalities, or changes in aqueous humor glucose optical rotation etc., these alterations may induce corresponding modifications in corneal curvature, birefringence effects, and scleral scattering characteristics. These changes are reflected in the cross-reference features of corneal polarization interference intensity patterns and/or scleral polarization scattering intensity patterns. By comparing with historical health record archives, trained deep learning models may perform dynamic qualitative/quantitative monitoring analysis and generate diagnostic feedback alerts.

As described in other embodiments, in some embodiments, the fixation system is further configured to guide fixation target. For head-mounted devices such as AR glasses, the fixation system may project a predetermined pattern onto the user's eye through an AR display assembly (e.g., image display source, optical waveguide, and input/output couplers) with a predetermined focal image distance (i.e., the focus distance of virtual images in the user's eye, such as 3 m, 5 m, or beyond). This projection establishes the predetermined pattern as a guided fixation target, wherein the eye maintains fixation on the pattern with stabilized visual/optical axes.

The fixation system may be configured to perform real-time display feedback of adjustment prompts by computationally analyzing iris imaging data and/or multiplexed eye-tracking (ET) imaging data. The prompt information includes, but is not limited to: XY-axis offset alignment of iris position, Z-axis movement of iris distance, pupil dilation degree, iris obstruction (e.g., by eyelashes, eyelids, or blinking), as well as fixation changes (e.g., Pitch/Roll/Yaw).

In some other embodiments, the fixation system may further be configured to display iris imaging data and/or multiplexed eye-tracking (ET) imaging data in real time.

In these embodiments, the fixation system is configured via the imaging control unit according to predetermined parameters (e.g., based on individualized optometric parameters) to:
(a) render the predefined fixation pattern in real time;
(b) analyze imaging data of the iris and/or eye; and
(c) generate adjustment prompts to guide fixation target throughout the operational sequence.

Consistent with other embodiments, the polarized eye illumination/imaging optics can be configured to, under predetermined eye rotational angular velocity conditions, define a predetermined pixel shift amount in the image plane during the illumination/imaging exposure period. Based on the eyeball radius Reye and the eye's rotational angular velocity Ω, the illumination/imaging exposure period TI/TF is constrained to satisfy the predetermined pixel shift amount MP.

In consistency with other embodiments, the polarized eye illumination/imaging optical unit may also be configured for visible-near infrared (VIS-NIR) wavelength multispectral illumination and imaging. In such embodiments, the polarized eye illumination optical unit may be configured to emit multi-wavelength-channel illumination across the VIS-NIR spectrum, while the polarized eye imaging optical unit may incorporate a corresponding pixelated multi-wavelength-channel filter. This filter may be stacked and integrated above the pixelated polarizer layer of the image sensor to extract pixelated multi-wavelength-channel information, thereby generating multi-polarization-state, multi-wavelength-channel pixelated imaging data.

As exemplified by the 660 nm and 940 nm wavelengths, the pixelated 4-channel configuration with 0-degree and 90-degree polarization states forms the following channels:
0-degree polarized 660 nm wavelength channel
90-degree polarized 660 nm wavelength channel
0-degree polarized 940 nm wavelength channel
90-degree polarized 940 nm wavelength channel.

Longer wavelength bands exhibit enhanced scleral penetration, such as 1050 nm near-infrared (NIR) radiation.

In some embodiment applications, the image sensor can be configured with a pixel binning/subsampling mode, in which pixels of the same polarization-state channel are combined to enhance sensitivity, reduce power consumption, or increase frame rate.

Although the eye illumination optical unit in the embodiments of the present disclosure exemplifies a light-emitting diode (LED) light source, which offers advantages such as low cost, high safety, and no requirement for laser protection, other embodiments may alternatively employ illumination sources such as superluminescent diodes (SLDs) or VCSELs, implemented with a floodlight and/or diffuser.

the imaging control unit may be implemented as the processor and the memory. In some examples, the imaging control unit may be implemented as hardware, software, and/or a combination of hardware and software in the HMD. In some examples, the imaging control unit may be implemented, in whole or in part, by at least one of any type of application, program, library, script, task, service, process, or any type or form of executable instructions executed on hardware such as circuitry that may include digital and/or analog elements (e.g., one or more transistors, logic gates, registers, memory devices, resistive elements, conductive elements, capacitive elements, and/or the like, as would be understood by one of ordinary skill in the art). In some examples, the processor may be implemented with a general purpose single-and/or multi-chip processor, a single-and/or multicore processor, a digital signal processor (DSP), an application specific integrated circuit (ASIC), a field programmable gate array (FPGA), or other programmable logic device, discrete gate or transistor logic, discrete hardware components, and/or any combination thereof suitable to perform the functions described herein. A general purpose processor may be any conventional processor, microprocessor, controller, microcontroller, and/or state machine. In some examples, the memory may be implemented by one or more components (e.g., random access memory (RAM), read-only memory (ROM), flash or solid state memory, hard disk storage, etc.) for storing data and/or computer-executable instructions for completing and/or facilitating the processing and storage functions described herein. In such examples, the memory may be volatile and/or non-volatile memory, and may include database components, object code components, script components, or any other type of information structure suitable for implementing the various activities and storage functions described herein.

In the embodiments of the present application, in order to achieve optimization of the eye/iris imaging image quality, the eye/iris imaging image quality standards are unified, and imaging system level imaging parameters and technical indicator requirements of the eye/iris imaging optical unit are stipulated to comprise at least one of data attributes:
the eye/iris imaging optical unit may be configured with imaging system pixel TV distortion, Distv<5% @1.0FOVi,
the eye/iris imaging optical unit may be configured with imaging system related illumination, RI=RIled*RIlens,
RI>30% @1.0FOVi,
Riled represents the related illumination when the illumination radiation angle of the near-infrared illumination optical unit is 1.0FOVi, and
RIlens represents the related illumination when the lens field of view for imaging of the eye/iris imaging optical unit is 1.0FOVi.

The eye/iris imaging optical unit may be configured with imaging system MTF=MTFsensor*MTFlens,
MTF>50% or e^{-1/2}@PF=Nyquist/4,
PF=Nyquist/EPS=1/(2*PS*EPS), and
EPS=PR/(2*MTFo),

where
PF represents the image spatial resolution/frequency,
MTFsensor represents a modulation transfer function value of the image sensor of the eye/iris imaging optical unit at PF,
MTFlens represents a modulation transfer function value of an imaging lens of the eye/iris imaging optical unit at PF,
MTFo represents a modulation transfer function value of the object spatial resolution/frequency of the eye/iris image quality at predetermined contrast, and
according to eye/iris image quality international standards of ISO/IEC 19794/29794-6, the lowest acceptable permissible MTFo=21 p/mm@contrast=50% or e^{-1/2}.

The minimum acceptable permissible PR=16 pixels/mm.

According to the eye/iris image quality standards in the international standards of ISO/IEC 19794/29794-6, EPS=4 pixels, i.e. 4 pixel scales. The EPS pixel scale is an important basic parameter for establishing a conversion association between the object spatial resolution and the image pixel spatial resolution of the eye/iris image quality. The main reason lies in that eye/iris image acquisition and subsequent image processing, image quality evaluation and algorithm recognition are all established on the basis of an image pixel unit, and the quality of an acquired eye/iris image can satisfy a predetermined standard by means of an image quality parameter established by means of the EPS association.

The embodiments of the present application, the minimum acceptable permissible PR and the lowest acceptable permissible MTFo may include, but is not limited to eye/iris image quality international standards of ISO/IEC 19794/29794-6.

In some examples, the EPS may be configured with PR<16pixels/mm and MTFo<21 p/mm@contrast=50% or e^{-1/2},such as PR=10 pixels/mm, MTFo=11 p/mm@contrast=50% or e^{-1/2}, EPS=5 pixels scale, the MTF may be configured to MTF>50% or e^{-1/2}@PF=Nyquist/5.

In some examples, further, the EPS may be configured with PR=20 pixels/mm, MTFo=11 p/mm@contrast=50% or e^{-1/2}, EPS=10pixels scale, the MTF may be configured to MTF>50% or e^{-1/2}@PF=Nyquist/10.

The eye/iris imaging optical unit may be configured with an aperture F of the imaging system, where
a range of F=m*PS is PS/um*EPS/8<F<PS/um*EPS/2,
F=m*PS=[⅛,½]*(PS*PR/MTFo)/um;
m=[EPS/8,EPS/2]/um.

The depth of field, imaging luminance and imaging quality requirements have been comprehensively considered in an optimized manner.

The eye/iris imaging optical unit may be configured with the imaging depth of field, DOFi=RZ>=2*m*EPS/PR2=m/(MTFo*PR)=[ 1/16,¼]*(1/MTFo2)/um.

Although fixation point stabilization can be made in the XR display content when biometric authentication is performed in actual scenarios, for example, UI is fixed to as to reduce the eyeball movement angular velocity. The eyeball movement angular velocity cannot be eliminated when it is adapted to use by complex populations, which includes physiological different muscle control changes.

The embodiments of the present application solve the problems that when the human eye observes the XR display content, a rapid movement of a fixation point causes rapid physiological rotation of a human eyeball, the eyeball movement blur caused by the rapid eyeball rotation directly affects the formed eye/iris image quality, resulting in failure of identity authentication are solved.

Detailed description will be further made below.

The imaging system of the eye/iris imaging optical unit may be configured as follows:
synchronization pulse global exposure period time TI is equal to LED synchronization pulse illumination radiation period time TF of the near-infrared illumination optical unit:

$$TI / TF < 10 ms ,$$

$$and$$

$$RAD ( TI ) * PR / EPS , RAD ( TI ) < 1 / ( 2 * MTFo )$$

$$where$$

$$RAD ( TI ) = Reye * sin ( Ω TI )$$

$$RAD ( TI ) = Reye * Ω * TI when Ω * TI << 1 ,$$

Reye represents a radius of an eyeball, which has an average value of 12 mm, and Ω represents a predetermined eyeball rotation angular velocity, which has a unit of rad/s.

In the embodiments of the present application, the eye/iris imaging control unit controls the synchronization pulse global exposure period time TI of the imaging system of the eye/iris imaging optical unit to be combined with the LED synchronization pulse illumination radiation period time TF of the near-infrared illumination optical unit to meet the MTFo spatial frequency/resolution requirements of the acceptable permissible eye/iris image quality standard under the condition of motion blur caused by the predetermined eyeball rotation angular velocity.

The problem that the quality of the eye/iris imaging image is affected by complex and powerful stray light including a non-imaging wavelength and an imaging wavelength in an outdoor environment is solved.

In the embodiments of the present application, for a non-imaging wavelength optical signal-to-noise ratio SNRoe, an imaging wavelength optical signal-to-noise ratio SNRoi, and an electrical signal-to-noise ratio SNRei of the eye/iris imaging optical unit,

SNRoe>80 db,

SNRoi>20 db, and

SNRei>40 db.

The near-infrared optical filter of the eye/iris imaging optical unit of the embodiments of the present application employs a narrow-band optical filter to suppress non-imaging wavelength interference, thereby playing a decisive role in improving the optical signal-to-noise ratio SNRoe configuration of the formed image quality. The narrow-band optical filter may be configured with the non-imaging wavelength transmittance which is controlled to be −60 db, that is, below 0.1%.

The near-infrared optical filter 850/940 nm of the eye/iris imaging optical unit may also be of a 30-60 nm narrow band, such that visible light (especially the highlight image display source visible light) is further filtered, near-infrared light is transmitted, and the optical SNRoe of the non-imaging wavelength stray light is increased to improve the noise quality of the formed eye/iris image.

For the eye/iris imaging optical unit, the employed irradiance Eeye/iris generated by an intensity of radiation of an LED light source of the near-infrared illumination optical unit on a surface of the eye/iris is greater than the irradiance Enoise formed by stray light (perpendicular incidence or scattering, reflecting the anisotropic incident noise light rays from all orientations) on the surface of the eye/iris within an imaging wavelength range, that is, Eeye/iris>Enoise.

The intensity of radiation IR of the LED light source of the near-infrared illumination optical unit plays a decisive role in suppressing noise light ray interference within the imaging wavelength range and improving the image quality optical signal-to-noise ratio SNRoi configuration, such that under the condition that a non-coherent light source LED eye biological radiation safety condition is satisfied, the intensity of radiation IR of the LED light source may be configured to the maximum.

According to the embodiments of the present application, the interference of noise light rays within the imaging wavelength range is suppressed, and the optical signal-to-noise ratio of the formed image quality is improved to satisfy the standard that SNRoi>20 db.

In fact, the quality of the imaging wavelength optical signal-to-noise ratio SNRoi may be superimposed to the non-imaging wavelength optical signal-to-noise ratio SNRoe to further improve the non-imaging wavelength optical signal-to-noise ratio.

An upper limit of the irradiance generated by the intensity of radiation IR of the LED light source of the near-infrared illumination optical unit on the surface of the eye/iris, Elimit=IR/Reyerelif²*TF*FP=IR/Reyerelif²*FI<10 mW/cm², thereby ensuring that the biological safety international standard of eye radiation is satisfied.

Furthermore, for a near-eye display scenario, the biometric process time is limited within 10 s, and retinal thermal radiation safety requires that the luminance of radiation (radiance) of the LED light source of the near-infrared illumination optical unit:

LR=IR/dA<28000/(dp/Reyerelif²)/cosθr with the unit: mw/sr/cm², where, dA represents a radiating area of the light source, and dp=π*16 mm², which is an exposure area at the maximum pupil.

As an important characteristic of the embodiments of the present application, related to the constant limited FP and Elimit, IR and TF keep an inverse dependence relationship, which means that joint optimization is performed. The lower synchronization pulse global exposure period time TI/synchronization pulse illumination radiation period time TF is, the better a generated controlled motion blur effect is. Moreover, the higher the intensity of radiation IR of the light source is, the more advantageous control and improvement of the non-imaging and imaging wavelength optical signal-to-noise ratios SNRoe/oi are.

In the embodiments of the present application, the pixel luminance Ipixel of a physically imaged eye/iris of the eye/iris imaging optical unit may be configured as follows:

$$1 / 4 MSB < Ipixel < 3 / 4 MSB ,$$

$$where$$

$$MSB represents the highest digital gray level in a full scale .$$

$$Ipixel = Coe * QE * ( Eeye / iris + Enoise ) * {( PS / 1 um )}^{2} * TI * CG * GAIN * ADC ,$$

$$where$$

$$Eeye / iris = IR / {Reyerelif}^{2} ,$$

$$or , furthermore ,$$

$$Eeye / iris = {cos}^{3} ( θ r ) * IR / {Reyerelif}^{2} = 2 * OP * {cos}^{3} ( θ r ) / π * {( PR / H )}^{2} ,$$

$$and$$

$$H = {( {PX}^{2} + {PY}^{2} )}^{1 / 2} , where$$

Ipixel represents the pixel luminance of the physically imaged eye/iris (the unit digital gray level LSB), Coe represents a photoelectric constant of the eye/iris imaging optical unit, and IR represents the intensity of radiation of the LED light source of the near-infrared illumination optical unit, which has the unit of mw/sr. QE represents photon-electron quantum conversion efficiency, which has the unit of e−/(mw*um²)/s, CG represents a conversion gain with the unit of mv/e−, and ADC represents analog voltage/digital luminance conversion, which has the unit of LSB/mv. PD represents a unit pixel density of the image sensor, which has the unit of um/pixel, and GAIN represents an analog gain with the unit of db. H represents the physical number of pixels of the image sensor, which has the unit pixel, and OP represents the optical power of radiation of the LED light source of the near-infrared illumination optical unit, which has the unit of mW.

As a characteristic, Eeye/iris and OP keep in a related constant relationship.

Furthermore, the embodiments of the present application employ the minimized GAIN, which includes, but not limited to, configuration of an analog gain, analog 0 dB and raw 1× are set, thereby reducing electrical noise interference from various sources, improving the contrast of the formed eye/iris image, and ensuring that the electrical signal-to-noise ratio of the formed eye/iris image satisfies SNRei>40 db. After the minimized GAIN is satisfied, furthermore, the conversion gain CG may be configured to be in a linear low/high conversion gain (LCG/HCG) output mode.

The eye/iris imaging control unit in the example of the embodiments of the present application controls the imaging parameter configuration of an eye/iris image frame, which includes, but not limited to, GAIN,CG,IR,TI/TF,FI,FR/FP, etc.

The eye/iris imaging control unit functionally controls the eye/iris imaging optical unit and the near-infrared illumination optical unit to generate an eye/iris image in a joint imaging mode, and an image frame period parallel synchronization logical time sequence imaging working mode is employed. For the image frame period parallel synchronization logical time sequence imaging working mode, in a current image frame period time sequence (Tn), the logical time sequence of the next image frame imaging parameter configuration effective period (TAn+1) and/or the next image frame INT exposure integration period (TIn+1)/FLASH synchronous illumination period (TFn+1) is synchronously executed in parallel in the current image frame readout period (TRn), and execution of the current image frame imaging parameter configuration effective period time sequence may be selected prior to the current image frame exposure integration period/synchronous illumination period time sequence. Moreover, an image frame processing calculation period (TCn−1) read by the previous image frame readout period (TRn−1) is performed in a parallel and synchronous superposition manner in the current image frame readout period (TRn).

Such an image frame period parallel synchronization logical time sequence imaging working mode method may be configured with a 100% maximized image frame utilization rate, that is, effective single frame by frame image readout is achieved.

In FIG. 9, a logical time sequence relationship of the image frame period parallel synchronization logical time sequence imaging working mode method is explained in detail.

For a time sequence in FIG. 9, n represents a serial number of a current image frame period, and the current image frame period Tn=TRn.

The current image frame readout period TRn is greater than the next image frame imaging parameter configuration effective period TAn+1 and the next image frame exposure integration period TIn+1/synchronous illumination period TFn+1, i.e., TRn>=TAn+1+TI/TFn+1 is satisfied, and parallel and synchronous execution of the logical time sequences of the next image frame imaging parameter configuration effective period Tan+1 and the next image frame exposure integration period TIn+1/synchronous illumination period TFn+1 is completed in the current image frame readout period TRn.

Moreover, the current image frame readout period TRn is greater than the image frame processing calculation period (TCn−1) read out by the previous image frame readout period (TRn−1), i.e., Tn=TRn>=TCn−1 is satisfied, and parallel and synchronous execution of the logical time sequence of the image frame processing calculation period (TCn−1) read out by the previous image frame readout period (TRn−1) is completed.

According to the above conditions, the time sequence Tn of the current image frame period of the embodiments of the present application satisfies the following conditions:

$$Tn = TRn >= ( TAn + 1 + TI / TFn + 1 ) ,$$

$$and$$

$$Tn = TRn >= TCn - 1.$$

In consideration of the fact that in an actual application scenario, FIG. 9 executes an efficient pipeline parallel processing and image processing flow, furthermore, an image frame processing calculation period (TCn−1) read out by the previous image frame readout period (TRn−1) is executed in a parallel and synchronous superposition manner in the current image frame readout period (TRn) in the example of the embodiments of the present application. It needs to be specifically noted that the next image frame imaging parameter depends on the historical image frame image processing calculation result prediction.

Generally, the eye/iris imaging control unit employs a constant frame rate, that is, the time sequence Tn of the frame period and the time T of the frame period are required to be kept constant.

According to the above frame period time sequence conditions, the time T of the current frame period of the embodiments of the present application should satisfy the following condition: T>=(TA+TI/TF), and when T=(TA+TI/TF), the frame rate corresponding to T is maximized.

the embodiments of the present application is related described when the equation is true to the maximum extent, which is not limited thereto, and should also be understood equivalently when T>(TA+TI/TF).

The frame rate FR, the synchronous exposure (integration) period frequency, the synchronization pulse illumination radiation period frequency FP, and a duty ratio FI of the eye/iris imaging control unit within the current image frame period satisfy:

$$FP = FR = 1 / T = 1 / ( TA + TI / TF ) ,$$

$$FI = ( TI / TF ) / T = ( TI / TF ) / ( TA + TI / TF ) ,$$

$$and$$

$$FI = TI / TF * FP / FR .$$

It needs to be specifically noted that TI/TF and FP/FR mean that TI or TF, and FP or FR.

In consideration of the fact that in an actual application scenario, under the equivalent condition and in the equivalent time, the frame period time is inversely proportional to the number of image frames captured by the eye/iris imaging control unit, the frame rate is directly proportional to the number of image frames captured by the eye/iris imaging control unit in unit time, which is conductive to improvement of a speed and a subsequent recognition rate.

In the embodiments of the present application, the actual power consumption and image frame rate are considered, which are configured as follows: 30 Hz(fps)<FP/FR<120 Hz(fps), and 3%<FI<30%.

In the embodiments of the present application, wherein the biometric authentication system trains the machine learning model to identify features of eye/iris of individual by analyzing a predetermined set of images of eye/iris of individual via an artificial neural network.

Some particular examples of the embodiments of the present application further includes measurement of individual biological activity of an XR head-mounted display, and such biological activity at least includes instances of physiological features, which include but not limited to:
a pupil constriction or dilation degree and a pupil constriction or dilation rate in response to light ray changes or in response to the particular human eye observation field of view content (visual image), and a contour shape change rate of pupil constriction or dilation, which includes, but not limited to, a diameter/radius ratio based on a related pupil,
a diameter/radius and time differential ratio based on a related pupil,
outer contour shape change rate counting based on a related pupil, and distance statistical measurement based on each outer contour point of the pupil and the pupil central point;
a range/amplitude, time, frequency and rate of a saccade/an anti-saccade/a microsaccade/a smooth pursuit movement in response to the particular human eye observation field of view content (visual image), which includes, but not limited to, the range/amplitude of peak to peak Vpp or max to min Vmm based on the movement; the time of peak to peak Tpp or max to min Tmm based on the movement; the frequency of peak to peak Fpp or max to min Fmm based on the movement; the rate of the range/amplitude and the time differential ratio based on the movement.
a pupil and/or eye/iris contour shape change rate in response to the particular human eye observation field of view content (visual image), which includes, but not limited to,
outer contour shape change rate counting based on the related pupil and/or eye/iris, and distance statistical measurement based on each outer contour point of the pupil/eye/iris and the pupil/eye/iris central point.

Schematically, distance statistical measurement at least includes, but not limited to,

$$Rave = SUM ( Ri ) / N ,$$

$$Rvar = {SUM ( Ri - Rave )}^{2} / N ,$$

$$Rnorm = Rvar / Rave ,$$

$$Rm = MIN ( Ri ) / MAX ( Ri ) ,$$

$$Rc = [ MAX ( Ri ) - MIN ( Ri ) ] / [ MAX ( Ri ) + MIN ( Ri ) ] ,$$

$$and$$

$$Ri = {[ {( xi - xc )}^{2} + {( yi - xc )}^{2} ]}^{1 / 2} , where$$

{(Xi, yi)} represents a coordinate set of contour points, (xc, yc) represents coordinates of a central point,

$$xc = SUM ( xi ) / N ,$$

$$yc = SUM ( yi ) / N ,$$

$$i = [ 1 , N ] , and$$

N represents the number of contour points.

In some examples, it is further configured: by means of eye tracking, the accuracy and reliability of individual biological activity measurement are improved in response to a real-time gaze movement trajectory of the eyeball of the particular human eye observation field of view content (visual image).

In some examples, the system further includes measurement of individual biological activity of an XR head-mounted display, and such biological activity at least includes polarization degree information of the formed image by configuring the orthogonal state orientation be to combined with polarization state imaging, thereby achieving the measurement of individual biological activity. More orthogonal state orientations are combined with the polarization state imaging to improve the accuracy and reliability of the measurement of individual biological activity.

In some examples, measurement of the physiological state data of the biological individuals of the XR head-mounted display is further included, which may be configured to achieve the functions of inspecting an individual health state and establishing a historical data record file. The physiological state data of the biological individuals includes statistical basis physiological state data of pupil constriction and/or dilation based on light ray changes or the particular human eye observation field of view content (visual image). In some examples, the light ray changes or the particular human eye observation field of view content (visual image) is achieved on the basis of the display imaging optical unit of the XR head-mounted display.

In some examples, the light ray changes or the particular human eye observation field of view content (visual image) may be configured to have a predetermined period time, frequency and luminance, and other various configurable parameter attributes, such as a predetermined period time of 100/200/300/500/1000 ms, predetermined frequency 0.1/0.5/½ Hz and predetermined luminance of 0.1/0.5/1 kLUX irradiance to eye.

In some examples, the light ray changes or the particular human eye observation field of view content (visual image) may be configured to respond to binoculus or unilateral eye, and a cross-contrast of the binocular (unilateral and contralateral) physiological state data is separately tested.

The physiological state data of the biological individuals includes, but not limited to:
1. a maximum value Pdil of the related pupil geometric parameter and/or pupil/iris geometric parameter ratio in response to a time point Tdil of pupil dilation state Sd, where in some examples, the pupil/iris geometric parameter includes, but not limited to: a radius, a diameter or a circumference, statistical measurement of a distance from an outer contour to a center, an axis length, an area and other alternative equivalent geometric parameter attribute expressions.
2. a minimum value Pcon of the related pupil geometric parameter and/or pupil/iris geometric parameter ratio in response to a time point Tcon of pupil constriction state Sc, where in some examples, the pupil/iris geometric parameter includes, but not limited to: a radius, a diameter or a circumference, statistical measurement of a distance from an outer contour to a center, an axis length, an area and other alternative equivalent geometric parameter attribute expressions.
3. a response amplitude ds of a value of peak to peak Vpp or a value of max to min Vmm based on a Sd-Sc and/or Sc-Sd period. In some examples, ds specifically includes, but not limited to,
ds=(Pdil−Pcon),
or for normalization,
ds=(pdil−pcon)/pdil.
4. a response time dt of time of peak to peak Tpp or time of max to min Tmm based on the Sd-Sc and/or Sc-Sd period. In some examples, dt specifically includes, but not limited to, dt=(Tdil−Tcon).
5. a response change rate dr of the response amplitude ds and the response time dt based on the Sd-Sc and/or Sc-Sd period. In some examples, dr specifically includes, but not limited to, dr=ds/dt.
6. a cross-contrast of the response amplitude ds based on the Sd-Sc and/or Sc-Sd period includes, but not limited to, a related amplitude, related difference of the response amplitude, and/or a related ratio Ads of the response amplitude, which is specifically Ads=(ds1−ds2) and/or Ads=ds1/ds2 Ads=1−ds2/ds1 in some examples,

Where
ds1 represents a response amplitude of a unilateral eye, and
ds2 represents a response amplitude of a contralateral eye.
7. a cross-contrast of the response time dt based on the Sd-Sc and/or Sc-Sd period includes, but not limited to, a related delay, related difference of the response time, and/or related ratio Tdelay of the response time, which is specifically Tdelay=(dt1−dt2) and/or Tdelay=dt1/dt2 Tdelay=1−dt2/dt1 in some examples, where
dt1 represents response time related a unilateral eye, and
dt2 represents response time corresponding to a contralateral eye.
8. a cross-contrast of the response change rate dr based on the Sd-Sc and/or Sc-Sd period includes, but not limited to, related change difference, related difference of the response change rate and/or related ratio Fdr of the response change rate, which is specifically Fdr=(dr1−dr2) and/or Fdr=dr1/dr2 Fdr=1−dr2/dr1 in some examples, where
dr1 represents a response change rate related a unilateral eye, and
dr2 represents a response change rate corresponding to a contralateral eye.

The above-mentioned Sd-Sc period refers to a transition process from a dilated state to a constricted state.

Being alternative and equivalent,

the above-mentioned Sc-Sd period refers to a transition process from a constricted state to a dilated state.
9. a range/amplitude, time, frequency and rate of an saccade/anti-saccade/microsaccade/smooth pursuit movement in response to the particular human eye observation field of view content (visual image), which includes, but not limited to, an angle and time differential ratio based on an angle of the movement and an angle of the movement within the unit time.

In some examples, the above-mentioned one of data attributes are used for the measurement of the physiological state data of the biological individuals. By means of the related biological individual physiological state data reference standard, the health data indicators of the current individual are tested and represented, which further includes, but not limited to, establishing a historical data record file of the current individual physiological state data in a non-volatile storage of a local device or by remotely uploading equivalent to a cloud/server by means of various communication networks so as to be used for a historical data contrast of the current biological individual and provide more medical purposes. In some examples, the related reference standard may contain basic health information of the current biological individual, which includes, but not limited to various physiological health information such as age, gender and basic diseases, thereby further improving the testing precision.

In some examples, the above-mentioned one or more of data attributes may be configured for the measurement of the physiological state data of the biological individuals may be used for biological activity measurement.

It should be noted that the biometric system of the embodiments of the present application includes, but not limited to, individual activity biological features such as an eye/iris, a retina, subcutaneous tissue of eyes, an ophthalmic artery/vein, and a sclera.

In the embodiments of the present application, the examples may also include one or more memory devices, such as memory. Memory generally represents any type or form of volatile or non-volatile storage device or medium capable of storing data and/or computer-readable instructions. In one example, memory may store, load, and/or maintain one or more of modules. Examples of memory include, without limitation, Random Access Memory (RAM), Read Only Memory (ROM), flash memory, Hard Disk Drives (HDDs), Solid-State Drives (SSDs), optical disk drives, caches, variations or combinations of one or more of the equivalent, or any other suitable storage memory.

In the embodiments of the present application, the examples may also include one or more physical processors, such as physical processor. Physical processor generally represents any type or form of hardware-implemented or software-implemented processing unit capable of interpreting and/or executing computer-readable instructions. In one example, physical processor may access and/or modify one or more of modules stored in memory. Additionally or alternatively, physical processor may execute one or more of modules to facilitate authenticating a user of an HMD. Examples of physical processor include, without limitation, microprocessors, microcontrollers, central processing units (CPUs), Field-Programmable Gate Arrays (FPGAs) that implement softcore processors, Application-Specific Integrated Circuits (ASICs), portions of one or more of the equivalent, variations or combinations of one or more of the equivalent, or any other suitable physical processor.

It should be noted that the technical features of the embodiments of the present application are not limited to the application scenarios of narrow head-mounted displays, and all devices with generalized display imaging functions are within the protection scope, such as a three-dimensional (3D) holographic projection devices and an augmented reality-ultra high definition (AR-UHD) device.

The display may utilize various display technologies, such as uLEDs, OLEDs, LEDs, liquid crystal on silicon, laser scanning light source, digital light projection, or combinations thereof. An optical waveguide, an optical reflector, a hologram medium, an optical combiner, combinations thereof, or other similar technologies can be used for the medium. In some implementations, the transparent or translucent display can be selectively controlled to become opaque. Projection-based systems can utilize retinal projection technology that projects images onto users' retinas. Projection systems can also project virtual objects into the physical environment.

It needs to be noted that the terms “some” and “at least one” mentioned herein refer to one or more, and the terms “multiple” and “at least two” refer to two or over two. The term “and/or”, which is an association relationship describing an associated object, means that there may be three relationships, for example, A and/or B may represent three situations: A exists alone, A and B exist at the equivalent time, and B exists alone. The character “/” generally represents that successive association objects are in an “or” relationship.

In addition, the terms “a” or “an,” as used in the specification and claims, are to be construed as meaning “at least one of.” Finally, for ease of use, the terms “including” and “having” (and their derivatives), as used in the specification and claims, are interchangeable with and have the equivalent meaning as the word “comprising.”

In the description of the present disclosure, it should be also noted that unless expressly specified otherwise, terms are to be understood broadly, for example, components may be fixedly connected, detachably connected or integrally connected. Those of ordinary skill in the art can understand the specific meanings of the terms in the present disclosure in accordance with specific conditions. In the specification of this description, reference terms “embodiments”, “one embodiment”, “some embodiments”, “an embodiment”, “example”, “an example”, “some particular examples”, or “some examples”, etc., mean that a particular feature, structure, material, or characteristic described in conjunction with the embodiment or example is included in at least one embodiment or example of the present disclosure. The above description are merely the examples of the present disclosure, and not intended to limit the present disclosure. Any modifications, equivalent replacements, improvements, etc. made within the principle of the present disclosure should all fall within the protection scope of the present disclosure.

Apparently, the above examples are merely examples given for clearly illustrating the embodiments of the present application, and are not intended to limit the embodiments. For those of ordinary skill in the pertained field, changes or variations in other forms may also be made on the basis of the above description. There are no need and no way to exhaust all the embodiments. Obvious modifications or variations made thereto shall still fall within the protection scope of the embodiments of the present application.

What is claimed is:

1. A biometric system for an extended reality head-mounted device, comprising: an imaging optical unit, a illumination optical unit, and an imaging control unit, wherein
the imaging optical unit is configured to image near-infrared incident light of an eye,
the illumination optical unit is configured to emit related near-infrared light for illuminating the eye, and
the imaging control unit is configured to control the imaging optical unit and the illumination optical unit to generate the eye image in a joint imaging mode.

2. The biometric system for an XR head-mounted device according to claim 1, wherein
the imaging optical unit includes an image sensor, an imaging lens, and a near-infrared optical filter;
the imaging optical unit is configured to directly or indirectly image from a predetermined imaging region of the eye.

3. The biometric system for an XR head-mounted device according to claim 2, wherein
the imaging optical unit is configured with an angular conversion optical element to convert an angular range of incidence into corresponding an angular range of emergence within a predetermined imaging field of view;
the angular range of incidence and the angular range of emergence is configured with a predetermined angular conversion relation.

4. The biometric system for an XR head-mounted device according to claim 3, wherein
the angular conversion optical element is configured with a principal optical axis of the imaging optical unit serving as a normal axis of a symmetry center;
the angular conversion optical element is configured with a predetermined low-order wavefront phase modulation function.

5. The biometric system for an XR head-mounted device according to claim 3, wherein
the angular conversion optical element is configured with at least one of
i) a first-order wavefront phase modulation function,
ii) an optical conjugation,
iii) a centrosymmetric angular range of emergence relative to the principal optical axis, and
iv) an angular optical compression from the angular range of incidence to the angular range of emergence.

6. The biometric system for an XR head-mounted device according to claim 3, wherein
the joint imaging mode is configured with the angular conversion optical element and the imaging lens in a cascaded arrangement.

7. The biometric system for an XR head-mounted device according to claim 6, wherein,
the angular range of emergence is configured as a field of view of the imaging lens in the joint imaging mode.

8. The biometric system for an XR head-mounted device according to claim 6, wherein
the imaging lens is configured to focus onto an image plane of the image sensor by an image-space near-telecentric configuration in the joint imaging mode.

9. The biometric system for an XR head-mounted device according to claim 6, wherein
the angular conversion optical element is configured as an aperture stop located at a front focal plane of the imaging lens in the joint imaging mode.

10. The biometric system for an XR head-mounted device according to claim 3, wherein
the angular conversion optical element is configured with a metasurface optical element or a diffractive optical element.

11. The biometric system for an XR head-mounted device according to claim 6, wherein
the imaging lens is configured with a metalens or a wafer-level optics imaging lens.

12. The biometric system for an XR head-mounted device according to claim 1, wherein
the illumination optical unit is configured to emit light with at least one of a polarization state to the eye;
the imaging optical unit is configured to capture an image using the image sensor that is sensitive to at least one of a corresponding polarization state;
the imaging control unit is configured to generate at least one of an identical and orthogonal polarization state combination, synchronize timing and process a polarization intensity data from the image.

13. The biometric system for an XR head-mounted device according to claim 12, wherein
the polarization intensity data is configured with at least one of a pattern modality of corneal polarization interference intensity or a pattern modality of scleral polarization scattering intensity serving as a cross-reference feature for characterizing the eye physiological state.

14. The biometric system for an XR head-mounted device according to claim 13, wherein
the imaging control unit is configured to perform end-to-end predictive inference to output dynamic qualitative/quantitative monitoring and analysis of the eye physiological state by pre-training with a high-dimensional mapped dataset of the cross-reference feature via a lightweight machine/deep learning model.

15. The biometric system for an XR head-mounted device according to claim 14, wherein
the cross-reference feature is configured to be defined based on manual feature extraction or autonomous high-dimensional feature extraction via a dual-or multi-channel feature disentanglement block in a machine/deep learning model.

16. The biometric system for an XR head-mounted device according to claim 12, wherein
the imaging control unit is configured with a fixation system to project a predetermined pattern as guided fixation target, analyze the image data, and provide feedback adjustment prompt.

17. The biometric system for an XR head-mounted device according to claim 12, wherein
the illumination optical unit is configured with multi-wavelength multi-polarization state across visible and near-infrared spectra;
the imaging optical unit is configured with corresponding pixelated multi-wavelength channel filters to capture an image of multi-wavelength multi-polarization state.

18. The biometric system for an XR head-mounted device according to claim 12, wherein
the polarization state is provided by a metasurface grating with a predetermined orientation, subwavelength period and depth.

19. An XR head-mounted device, being applied to biometrics of at least one of an eye/iris, a retina, subcutaneous tissue of eyes, an ophthalmic artery/vein, and a sclera in the biometric system for an XR head-mounted device according to claim 1.

20. An XR head-mounted device, being multiplexed for eye tracking by the biometric system for an XR head-mounted device according to claim 1.
